(19) United States
(12) Patent Application Publication
(10) Pub. No.: US 2010/0223175 A1
(43) Pub. Date: Sep. 2, 2010

(54) METHOD AND SYSTEM FOR STANDARDIZING BILATERALLY-NEGOTIATED DERIVATIVE POSITIONS

(75) Inventors: Tom Miglis, Woodbury, NY (US); Josef Saniga, Valparaiso, IN (US); Puneet Jain, Naperville, IL (US)

Correspondence Address: MARSHALL, GERSTEIN & BORUN LLP, 233 SOUTH WACKER DRIVE, 6300 WILLIS TOWER, CHICAGO, IL, 60606-6357, US

(73) Assignee: KCG IP HOLDINGS LLC, Chicago, IL (US)

(21) Appl. No.: 12/608,736

(22) Filed: Oct. 29, 2009

Related U.S. Application Data
(60) Provisional application No. 61/109,492, filed on Oct. 29, 2008.

(51) Int. Cl. G06Q 40/00

(52) U.S. Cl. 705/37

(57) ABSTRACT

A method of converting a portfolio of non-standard credit default swap (CDS) trades standardized CDS trades. The method includes receiving electronically multiple non-standard CDS trades. Each of the multiple non-standard CDS trades includes at least an initial notional amount and an initial coupon rate. The method further includes converting each of the multiple non-standard CDS trades into two standardized CDS trades. The two standardized CDS trades include a first standardized CDS trade at a first coupon rate of 100 basis points (bps) and a second standardized CDS trade at a second coupon rate of 500 bps. The method further includes determining a first notional amount for the first standardized CDS trade and a second notional amount for the second standardized CDS trade such that a sum of the first notional amount and the second notional amount is equal to the initial notional amount, and a sum of the first notional amount multiplied by the first coupon rate and the second notional amount multiplied by the second coupon rate is equal to the initial notional amount multiplied by the initial coupon rate.

### CROSS-REFERENCE TO RELATED APPLICATIONS

This application claims benefit of the following U.S. Provisional Application Ser. No. 61/109,492, entitled “Method and System of Standardizing Bilaterally-Negotiated Derivative Positons” filed Oct. 29, 2008, the disclosure of which is hereby expressly incorporated herein by reference.

### TECHNICAL FIELD

The present application relates generally to computing systems and more specifically to a computing system for migrating bilaterally-negotiated derivative positions to standard contracts.

### BACKGROUND

An Over-the-Counter (OTC) trading market is a decentralized market of traded financial instruments, in which parties may negotiate bilateral derivative contracts privately and directly (e.g., over the telephone, facsimile or electronic network) instead of via a central exchange, a Request for Quote (RFQ) facility, or a physical meeting place (e.g., a physical trading floor). One example of a bilaterally-negotiated derivative contract that is generally traded over the counter is a credit default swap (CDS) contract. In a credit default swap (CDS) contract, a first party (usually known as the protection buyer) pays a fee or premium, usually in the form of periodic payments, to a second party (generally referred to as the protection seller) and receives from the second party a promise of a payoff if a third party (generically referred to as reference entity) defaults, or if some other credit event occurs.

Because bilateral derivative contracts, such as CDS contracts, are generally traded over the counter as agreements between two private parties, such contracts are characterized by non-standardized terms and parameters (e.g., variable maturity dates, issue dates, rates, etc.). As such, the actual market value of such derivative contracts is difficult to gauge with respect to other similar contracts. This difficulty in valuation of bilateral derivative contracts makes trading or exchanging existing bilateral derivative contracts difficult to implement and unattractive to buyers external to the originating parties.

Accordingly there is generally a need for a mechanism of converting bilaterally-negotiated derivative contracts into standard contracts. Such standardized contracts would be easier to valuate, net, and trade e.g., on an exchange or via and RFQ facility.

### BRIEF DESCRIPTION OF THE DRAWINGS

FIG. 1 illustrates an exemplary computing system which may be used to implement portions of the described process;

FIG. 2 illustrates cash flows or a coupon bond;

FIG. 3 illustrates operation of a credit default swap between two parties;

FIG. 4 illustrates exemplary components of a CDS index designation;

FIG. 5A illustrates high-level architecture of an exemplary migration system;

FIGS. 5B-5C illustrate a more detailed architecture of an exemplary migration system of FIG. 5A;

FIG. 6 illustrates one exemplary process of converting a single bilaterally-negotiated CDS contract to a cleared contract;

FIG. 7 illustrates one exemplary process of converting a portfolio of bilateral CDS contracts to a standardized form and migrating it to the Central Counterparty Clearing Entity;

FIG. 8 illustrates an exemplary portfolio migration& substitution clearing of converted positions;

FIG. 9 illustrates an exemplary interface embodiment for administrating portfolios;

FIG. 10 illustrates an exemplary interface embodiment for viewing portfolio input status and information;

FIG. 11 illustrates an exemplary interface embodiment for viewing portfolios of bilaterally-negotiated contracts;

FIG. 12 illustrates an exemplary interface embodiment for viewing portfolios of migrated contracts;

FIG. 13 illustrates an exemplary interface embodiment for analyzing portfolios of uploaded bilaterally-negotiated contracts;

FIG. 14 illustrates an exemplary interface embodiment for analyzing portfolios of migrated and cleared contracts:

FIG. 15 illustrates an exemplary interface embodiment for analyzing the status of migrated contracts;

FIG. 16 illustrates an exemplary interface embodiment for viewing a migration snapshot alit portfolio CDS contracts;

FIG. 17 illustrates an exemplary interface embodiment for viewing a snapshot of a given clearing member;

FIG. 18 illustrates an exemplary interface embodiment for view a discount associated with an owner;

FIG. 19 illustrates an exemplary interface embodiment for viewing a global discount;

FIG. 20 illustrates an exemplary interface embodiment for viewing various fees associated with migration;

FIG. 21 illustrates an exemplary interface embodiment for viewing administrative actions associated with migration;

FIG. 22 illustrates an exemplary interface embodiment for viewing costs associated with migration;

FIG. 23 illustrates an exemplary interface embodiment for viewing margin information associated with a portfolio of contracts;

FIG. 24 illustrates an exemplary interface embodiment for displaying a migration schedule;

FIG. 25 illustrates an exemplary web interface embodiment for a uploading and downloading files to and from the Migration Utility 530 and to display information related to margin eligibility;

FIG. 26 illustrates an exemplary web interface embodiment for viewing the migration status;

FIG. 27 illustrates an exemplary web interface embodiment for viewing the trades;

FIG. 28 illustrates an exemplary web interface embodiment for viewing eligible contracts; and

FIG. 29 illustrates an exemplary web interface embodiment for viewing various information about user:

### DETAILED DESCRIPTION

Although the following text sets forth a detailed description of numerous different embodiments, it should be understood that the legal scope of the invention is defined by the words of the claims set forth at the end of this patent. The detailed description is to be construed as exemplary only and does not describe every possible embodiment since describing every possible embodiment would be impractical, if not impossible. Numerous alternative embodiments could be implemented, using either current technology or technology developed after the filing date of this patent, which would still fall within the scope of the claims.

It should also be understood that, unless a term is expressly defined in this patent using the sentence “As used herein, the term ‘______’ is hereby defined to mean . . .” or a similar sentence, there is no intent to limit the meaning of that term, either expressly or by implication, beyond its plain or ordinary meaning, and any term not so defined herein should not be interpreted to be limited in scope based on any statement made in any section of this patent (other than the language of the claims).

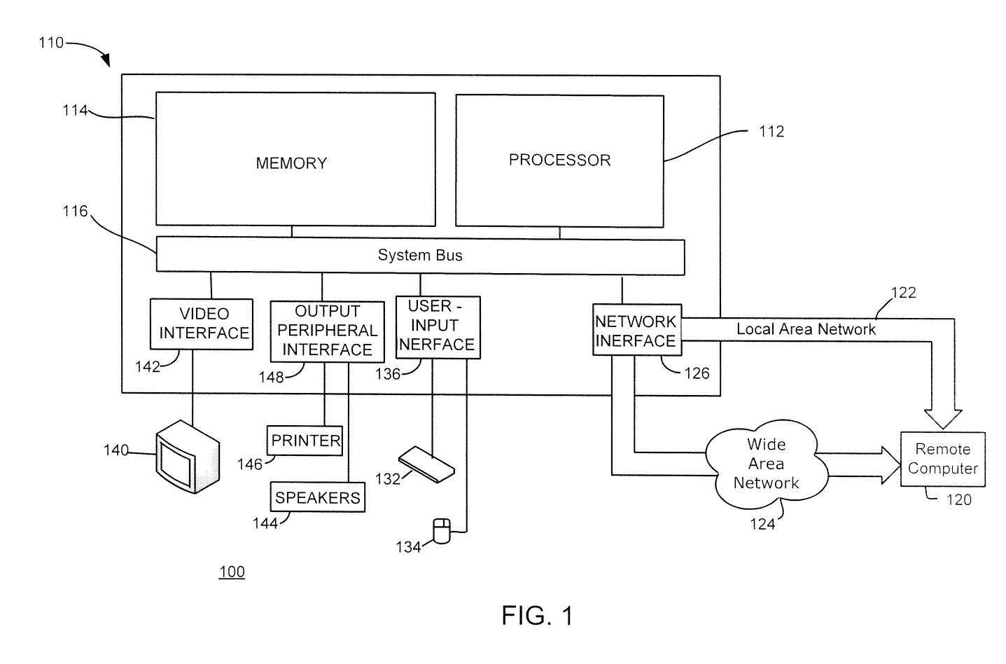

FIG. 1 illustrates an exemplary computing system 100 which may be used to implement a process as described herein. The computing system 100 includes a computer 110 that may be used to implement any blocks of the claimed method and apparatus. Components of computer 110 may include, but are not limited to, a processing unit 112, a system memory 114, and a system bus 116 that couples various system components, including the system memory 114 to the processing unit 112. Generally speaking, the system memory 114 includes computer-readable instructions, and the processing unit 112 executes the computer-readable instructions to perform various functions, such as those described below.

Computer 110 typically includes a variety of computer storage media that may be any available media that may be accessed by computer 110 and includes both volatile and nonvolatile media, removable and non-removable media. For example, the system memory 114 may include computer storage media in the form of volatile and/or nonvolatile memory such as read only memory (ROM) and random access memory (RAM). The computer 110 may also include other removable/non-removable, volatile/nonvolatile computer storage media (not shown) such as a hard disk drive, a magnetic disk drive that reads from or writes to a magnetic disk, and all optical disk drive that reads from or writes to an optical disk. The computer 110 may operate in u networked environment using logical connections to one or more remote computers, such us a remote computer 120, via a local area network (LAN) 122 and/or a wide area network (WAN) 124 a network interface 126.

A user may enter commands and information into the computer 110 through input devices such as a keyboard 132 and pointing device 134, commonly referred to as a mouse, trackball or touch pad. Other input devices (not illustrated) may include a microphone, joystick, game pad, satellite dish, scanner, or the like. These and other input devices are often connected to the processing unit 112 through a user input interface 136 that is coupled to the system bus 116, but may, similar to the sensor devices, be connected by other interface and bus structures, such as a parallel port, game port or a universal serial bus (USB). A monitor 140 or other type of display device may also be connected to the system bus 116 via an interface, such as a video interface 142. In addition to the monitor, computers may also include other peripheral output devices such as speakers 144 and printer 146, which may be connected through an output peripheral interface 148. The computer 110 and/or computing system 100 may be used to implement various aspects of the process and system described below.

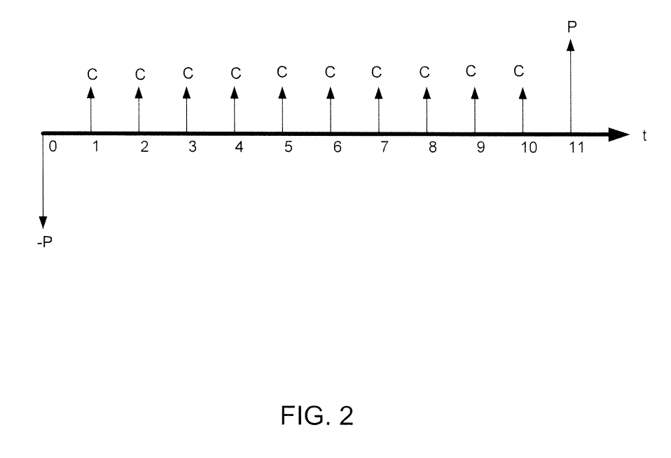

In finance, a financial bond is a debt security in which an issuer of the bond owes a purchaser (or holder) of the bond a debt. The issuer is obliged to pay a periodic coupon payment while owning the debt and repay the principal (and sometimes interest) at a later date, termed a maturity date. The issuer may represent a borrower, the bond holder may represent a lender, and the coupon payment may represent interest. FIG. 2 illustrates a series of cash flows representing a bond having periodic coupon payments. In this example, at time zero, a purchaser of the bond pays out a principle amount P to the issuer of the bond. During the time to maturity, the bond purchaser receives period coupon payments C until maturity date M, where the purchaser receives the principal payment P.

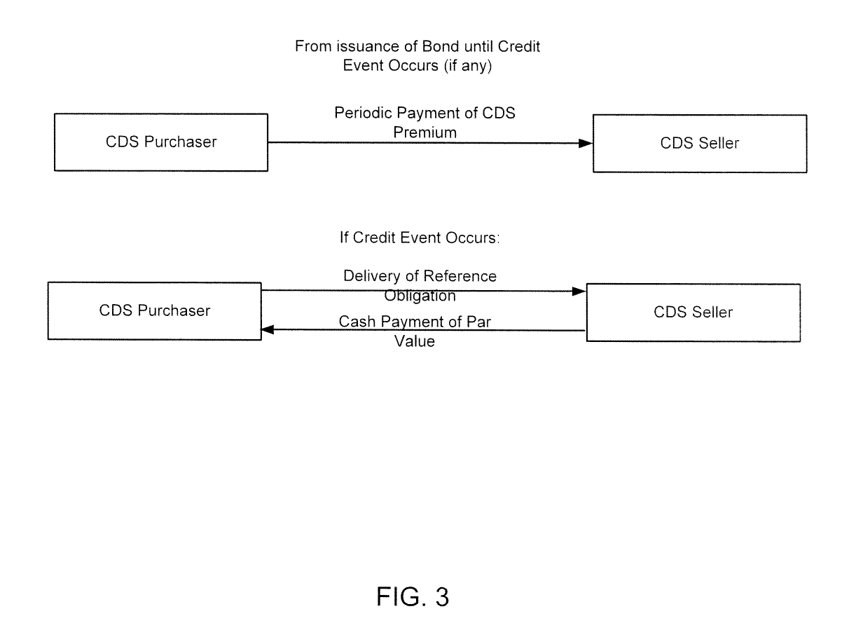

A swap is a derivative product in which two counterparties agree to exchange one stream of cash flows a fixed stream) against another stream of cash flows (e.g., a variable stream). FIG. 3 illustrates a credit derivative swap (CDS) which is a specific type of swap in which a seller of the swap guarantees the face value (or notional amount) of a bond if the issuer of the bond defaults. As illustrated in FIG. 3, a buyer or purchaser of the swap agrees to pay a premium (usually in the form of periodic payments) to the seller for the default guarantee. In this case, the bond may represent an underlying asset for the credit derivative, the seller may represent an insurer against a credit event involving the underlying asset default of the bond), and the buyer may represent the owner of the bond. If no credit event occurs, then the CDS buyer continues payment of the premium until the contract expires. If a credit event occurs, the buyer may deliver the reference obligation to the CDS seller in exchange for an agreed upon cash amount (e.g., cash payment of par value).

CDS contracts may be used for hedging or speculation. For hedging purposes, credit default swaps may be used to manage credit risk in holding a company/corporate bond without necessitating the sale of the underlying bond. In other words, owners of a corporate bond can protect themselves from default risk by purchasing a credit default swap on that company or reference entity. Credit default swaps may be used in a speculative manner by betting on changes in a company's credit quality. For example, if one believes that a company's credit risk will increase, they can purchase a swap priced on a current credit rating of the company and cash in on the swap when the company defaults or by selling the swap. A “protection” seller in a credit default swap effectively has an unfunded exposure to the underlying cash bond or reference entity, with a value equal to the notional amount of the CDS contract. The notional amount (a.k.a notional principal amount or notional value) on a financial instrument is the nominal or face value that is used to calculate payments made on that instrument. This amount generally does not change hands and is thus referred to as notional.

### Terms of a Bond

Table 1 lists general terms of a financial bond having periodic coupon payments. The parameters of the bond may include (among other parameters), an issuer, and issue date, a maturity date, a face value, a coupon, a yield, a price, a payment frequency, and an interest payment amount. The bond example in Table 1 has an issue date of Jan. 20, 2007 and a maturity date of Jan. 20, 2012, making this a 5 year bond

TABLE 1

| Issuer/Reference Entity/Name: | ABC Corporation |
|---|---|
| Issue Date: | Jan. 20, 2007 |
| Maturity Date: | Jan. 20, 2012 |
| Face Value: | $10,000,000 |
| Coupon: | 7% |
| Yield To Maturity: | 7% |
| Price at Issuance: | 100% of Face Value |
| Payment Frequency: | Quarterly |
| Interest Payment: | 175,000 |

The issuer of the bond in Table 1 is ABC corporation. The coupon payment is 7 percent over 5 years (time between Jan. 20, 2007 and Jan. 20, 2012). The coupon of 7 percent means that the issuer of the bond will pay 7 percent of the face value ($10 Million) on a quarterly basis ($175,000 per quarter).

Interest payments are generally calculated as

$$\frac{\frac{FACEVALUE \times COUPON}{100}}{4} .$$

The interest may also be called the yield or yield to maturity.

At maturity, the issuer may be required to pay the face value of $10 Million. At issuance, the buyer of the bond may pay to the issuer the present value of the bond at issuance, where the present value may be calculated based on the present value of the coupon payments (discounted by the interest rate or yield) plus the present value of the face value of the bond (discounted by the interest rate or yield).

In the example shown in Table 1, the coupon rate and the yield are equivalent. When the coupon rate and interest rate (yield or yield to maturity) are equal, the initial present value of the bond and the face value at maturity are equivalent, where the issuer pays coupon payments that just cover the loan interest. In this case the bond is said to be trading at par. It should be noted that bonds are not always issued at par (100% of face value, corresponding to a price of 100), but all bond prices converge to par when they reach maturity. This is because if the prices do not converge, arbitrageurs can make risk-free profit by buying the bonds at a discount and collecting the face value at maturity. As a note, the bond illustrated in FIG. 2, is issued at par.

The interest rate that the issuer of a bond must pay is influenced by a variety of factors, such as current market interest rates, the length of the term and the credit worthiness of the issuer. These factors are likely to change over time, so the market value of a bond can vary after it is issued. Because of these differences in market value, bonds are priced in terms of percentage of par value, as indicated in Table 1.

### Terms of a CDS Contract

Table 2 illustrates general terms or parameters of a single-name CDS contract.

TABLE 2

| | |
|---|---|
| Reference Entity | ABC Corporation |
| Reference Credit | BB |
| Reference Obligation | $10 Million |
| Credit Event | Bankruptcy/Failure to Pay |
| Calculation Agent | GHJ |
| Effective Date | Jan. 20, 2003 |
| Scheduled Termination Date | Jan. 20, 2013 |
| Notional Amount | $10 Million |
| RATE | 200 b.p. |
| Payment Schedule (frequency) | Quarterly |

A CDS contract is typically documented under a confirmation referencing the Credit Derivatives Definitions as published by the International Swaps and Derivatives Association (ISDA). The confirmation typically specifies a reference entity or a bond issuer which is usually a corporation or sovereign that generally has debt outstanding. Table 2 illustrates that example corporation ABC corporation is a reference entity (issuer) of a bond. Generally, a CDS contract is a single-name CDS contract when there is only a single issuer or single reference entity involved in the contract. When a CDS involves multiple reference entities, the CDS may be named a multi-reference CDS.

The confirmation also specifies a reference obligation which may be a corporate bond or government bond. Included in the details of the reference obligation may be parameters or terms of the bond. The confirmation may highlight the credit rating of the reference entity or this information may be part of the reference obligation description. In the example of Table 2, the ABC Corporation bond is rated BB. The period over which default protection extends is defined by the contract effective date and scheduled termination date. The contract may define the credit event that is being guaranteed, when the bankruptcy or failure to pay of ABC corporation. The swap contract also specifies a rate, which indicates a premium that the buyer or the swap contract sends to the seller and a payment schedule. The rate is generally quoted in basis points (or hundredths or a percentage point where 100 basis points is equal to 1 percent).

CDS confirmations also specify the credit events that Will trigger payment obligations by the protection seller and delivery obligations by the protection buyer. Typical credit events include bankruptcy with respect to the reference entity and failure to pay with respect to its direct or guaranteed bond or loan debt. CDS contracts written on North American investment grade corporate reference entities, European corporate reference entities and sovereigns may also include restructuring as a credit event, whereas trades referencing North American high yield corporate reference entities typically do not. Restructuring may include circumstances where a reference entity, as a result of the deterioration of its credit, negotiates changes in the terms in its debt with its creditors as an alternative to formal insolvency proceedings. Because credit events can be hard to define, this additional variability further adds to the transparency problem of CDS contracts.

Following is an example to illustrate the operation of a credit default swap. A pension fund XYZ owns $10 million worth (face value) of a five-year bond (period between issue date and maturity date of bond) issued by ABC Corporation. To manage the risk of losing money if ABC Corporation defaults on its debt, the pension fund XYZ may buy a CDS from Bank T in a notional amount of $10 million that trades at 200 basis points. In this case, the rate of the swap is 200 basis points. This means that the pension fund XYZ pays 2% (200 basis points) of 10 million (or $200,000) in quarterly installments of $50,000 to Bank T. If ABC Corporation does not default on its bond payments, the pension fund makes quarterly payments to Bank T for 5 years and receives its $10 million loan back after 5 years from the ABC Corporation. Although the protection payments reduce investment returns for the pension fund, its risk of loss in a default scenario may be eliminated. If ABC Corporation defaults on its debt 3 years into the CDS contract, the pension fund may stop paying the quarterly premium, and Bank T would ensure that the pension fund is refunded for its loss of $10 million (either by taking physical delivery of the defaulted bond for $10 million or by cash settling the difference between par and recovery value of the bond).

### Single-Name CDS Contracts and Multi-Reference (Index) CDS Contracts

Currently, there are no standardized single-name credit default swaps traded over an exchange. This may be due in large part to the lack of transparency for default swap contracts. In economics, a market for a product has transparency when there is a large amount or easily available information on the price or value of the market product. Transparency is important since it is one of the theoretical conditions required for a free market to be efficient. Lack of transparency may hinder the demand for trading a product, in particular because buyers and sometimes sellers cannot easily determine the value or the good.

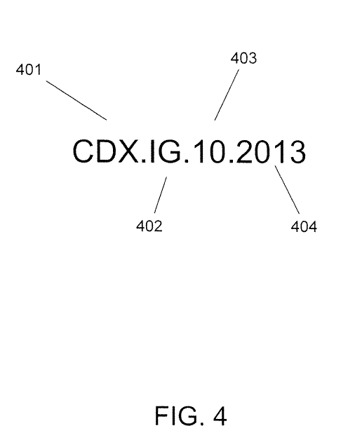

While there is currently no standardized single-name credit default swaps, certain market participants offer for sale on an exchange an index on standardized credit default swaps (multi-reference CDS) for a basket of reference entities. FIG. 4 illustrates a notation used for indexed credit default swaps. A first identifier 401 in the notation indicates the type of index. In this case, CDX may involve a basket of 125 reference entities or issues of bonds. These 125 reference entities may be chosen for a particular industry.

A second identifier 402 in the notation may indicate the credit rating of the companies in the indexed basket. Generally, the rating may be investment grade (IG), near investment grade (XO), or high yield (HY), which is below XO. Generally, a bond that is rated as A or higher may be included in the IG category. HY may be used to designate a basket of bonds where each reference entity in the basket is BBB or lower. The second identifier 402 illustrates that this particular multi-reference CDS is for investment grade bonds.

A third identifier 403 in the notation may indicate the time to maturity of the bonds in the basket. In FIG. 4, the period is 10 years. Of course other periods may be used (e.g., 2, 5, 7, 15, 20 etc.). A fourth identifier 404 in the notation may indicate the maturity date, which is indicated as the year 2013 for the FIG. 3 example.

Generally, buying $10 million of the CDS index means that the protection is spread out across the 125 reference entities. Thus, if ABC corporation is part of the basket and ABC corporation defaults, then the value provided to the purchaser of the CDS is $10 million divided by 125 or $80,000.

A CDS index provides a standardized issuance of credit default swaps which can be compared against other default swaps of the same type. In particular, standardization of a CDS may indicate that a fixed rate, a fixed date/effective date, and a fixed maturity date are set for the contract. In this case, standardization way provide contracts that are nettable. In general, netting means to allow a positive value and a negative value to set-off and partially or entirely cancel each other out. To illustrate a series of nettable transactions. Table 3 below illustrates buy and sell orders for a particular index or multi-reference entity CDS:

TABLE 3

| | | |
|---|---|---|
| Jul. 11, 2008 | Bought10 | CDX.IG.10.2013 |
| Jul. 11, 2008 | Sold 3 | CDX.IG.10.2013 |
| Jul. 12, 2008 | Bought20 | CDX.IG.10.2013 |
| Jul. 13, 2008 | Sold 10 | CDX.IG.10.2013 |
| NET | Bought17 | CDX.IG.10.2013 |

The CDS contracts of Table 3 are nettable because the purchase and sale of these contracts can be added to provide an equivalent net transaction. Buying seventeen of CDX.IG.10.2013 is equivalent to the series of transactions performed in July. Because netting allows a party to easily understand the exposure or value of a series of existing nettable obligations and assets, netting generally decreases credit exposure, increases business with existing counterparties, and reduces both operational and settlement risk and operational costs. Generally, nettable securities make financial clearing easier, where financial clearing is an important component for an efficient exchange. Clearing denotes all activities from the time a commitment is made for a transaction until it is settled. Clearing is necessary because the speed of trades is much faster than the cycle time for completing the underlying transaction.

Table 4 illustrates a set of single-name default swaps that are originated between two private parties: a reference entity and a purchaser. These single-name default swap contracts are non-standard and thus, not nettable. In particular, each contract has different rates, maturity dates, and issue dates. This difference is attributed to the fact that the contracts are originated at arbitrary times that are determined only when the reference entity and purchaser agree to make the contract (time of origination).

TABLE 4

| Date | Transaction/Entity | Rate | Maturity |
|---|---|---|---|
| Jul. 11, 2008 | Bought ABC | 1200 | Jun. 20, 2013 |
| Jul. 11, 2008 | Sold ABC | 1250 | Jun. 20, 2013 |
| Jul. 12, 2008 | Bought ABC | 1300 | Jun. 21, 2013 |
| | DO NOT ADD | | |
| | DO NOT NET | | |

Even if some contracts have the same maturity dates (e.g., the first two rows of Table 4), their issue dates may be different, and thus, may not be added easily. In other words, while the values of the contracts may be determined or estimated using various algorithms, these contracts are not easily added (e.g., without using complex mathematical algorithms) based solely on their published terms. As discussed above, because of the non-standard nature of these CDS contracts, these CDS contracts are traded over the counter (OTC) between two specific counter parties. The purchaser of an existing CDS contract generally has the responsibility of valuing the CDS contract and determining whether the contract is worth purchasing. As discussed above, different valuation methods may be used and the valuation method may be arbitrary. Thus, the transparency of single-name default swap contracts is low and the incentive to trade these contracts in large volume across an exchange is low. This may prevent the adoption of an exchange for these types of contracts.

Generally, an exchange is a platform where various products are traded. For example, a commodities exchange is an exchange where various commodities and derivatives products are traded. Most commodity markets across the world trade in agricultural products and other raw materials (like wheat, sugar, maize, cotton, coffee, milk products, pork bellies, oil, metals, etc.) and contracts based on them. These contracts can include spot prices, forwards, futures and options on futures. Other sophisticated products may include interest rates, environmental instruments, swaps, or ocean freight contracts.

### Migrating Existing Bilateral Contracts into a Standardized Form

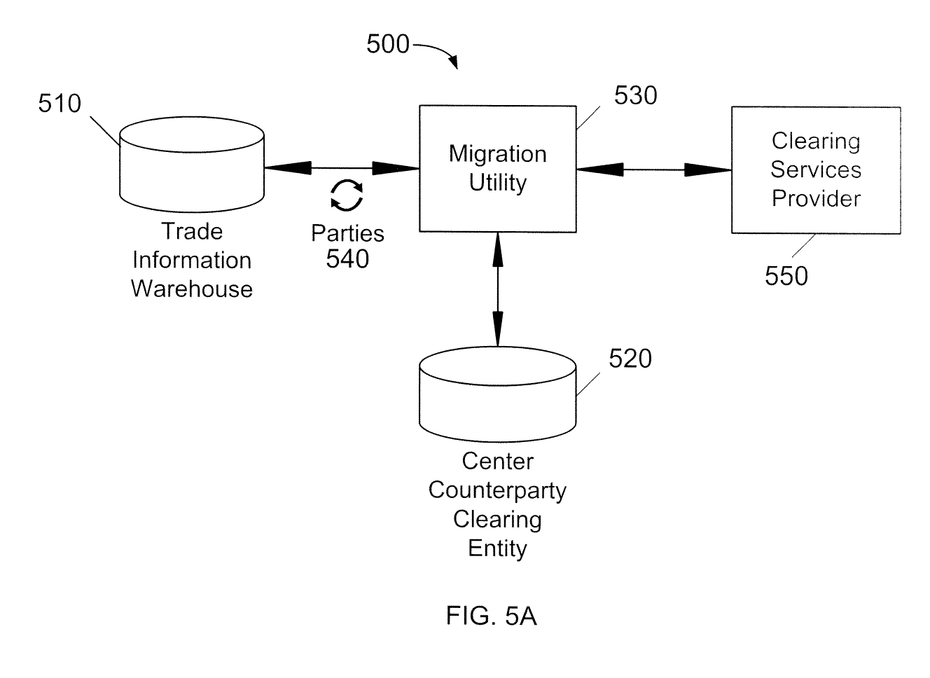

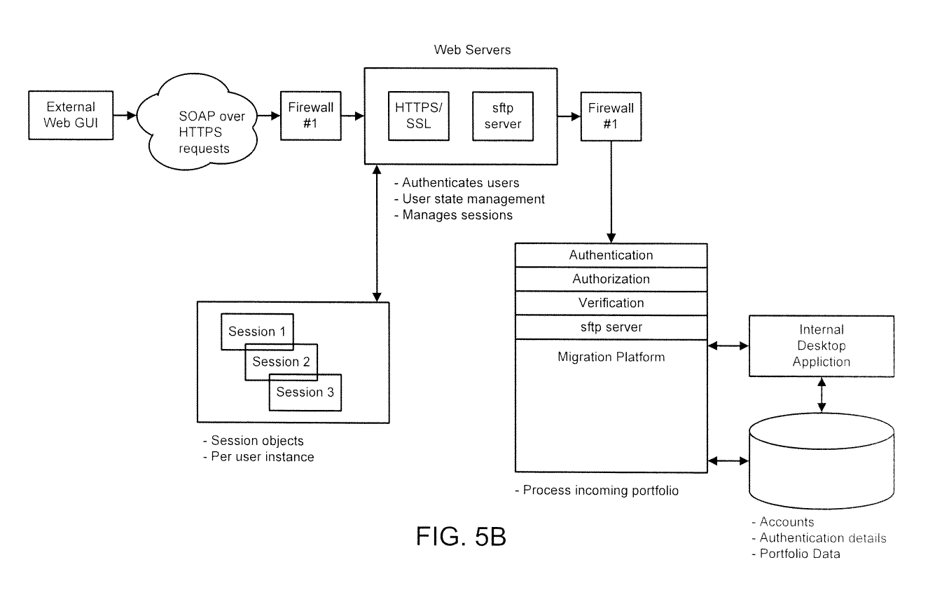

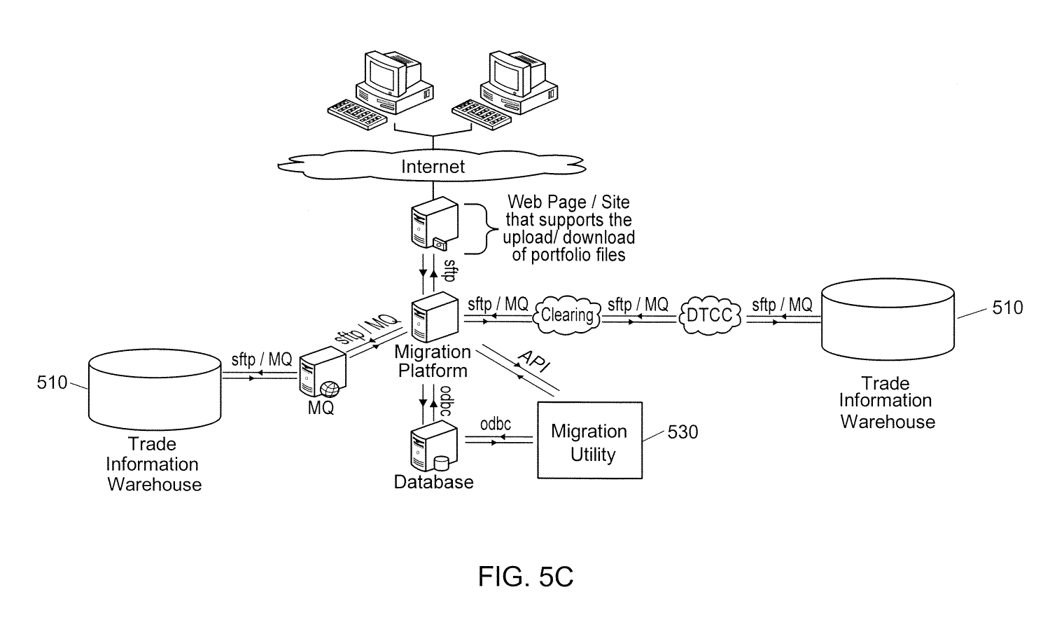

FIG. 5A illustrates high-level architecture of an exemplary migration system 500. In general terms, the Migration Utility 530 may receive bilaterally-negotiated CDS contracts (also referred to as “non-standard CDS contracts,” or “non-standard CDS trades”), e.g., from Trade Information Warehouse 510, or from a user input, convert, or re-coupon these non-standard CDS contracts into standard CDS contracts, and thus migrate the non-standard CDS contracts to a Central Counterparty Clearing Entity 520. The term “migration” is used herein to mean to transmogrification, conversion (e.g., re-couponing), and/or novation of an existing bilaterally-negotiated derivative contract to a cleared contract. The Migration Utility 530 may be implemented on a migration computing system such as the computing system 100 illustrated in FIG. 1. However, it will be understood that the Migration Utility 530 may also be implemented on other computing systems.

The Trade Information Warehouse 510 may be a centralized and secure global infrastructure for processing over-the-counter derivatives over their life cycle. It may include a comprehensive trade database and a central technology infrastructure. The comprehensive trade database can hold the primary record of each OTC contract. The central technology infrastructure can automate trade processing, such as record keeping, payment calculations and settlement, notional adjustments and contract term changes over a contract's life. An example of a Trade Information Warehouse 510 is the DTCC Deriv/SERV TIW available from the Depository Trust & Clearing Corporation.

In general, Parties 540 (also referred to as “participants” and/or “counterparties”) to a bilateral CDS contract may submit their portfolios of contracts (or portions thereof) either to the Trade Information Warehouse 510 or directly to the Migration Utility 530. In sonic implementations, the Migration Utility 530 may have access to the Trade Information Warehouse 510 to access the parties' 540 portfolios, if the parties 540 choose to submit their portfolios to the Trade Information Warehouse 510.

Once the Migration Utility 530 retrieves the participants' bilaterally-negotiated CDS contract, the Migration Utility 530 can convert (e.g., re-coupon) to standard contracts and migrate them to the Central Counterparty Clearing Entity 520. The Migration Utility may interface with any Clearing Services Provider 550 that can fulfill the role of a central counterparty prime broker or Clearing member of the Central Counterparty Clearing Entity 520 for cleared contracts. One example of a Clearing Services Provider 550 is Clearing Corporation (CCorp).

FIGS. 5B-5C illustrate a more detailed architecture of an exemplary migration system 500 discussed in reference to FIG. 5A. Referring to FIG. 5B, the Migration Utility 530 may be running on a migration platform. The migration platform may be accessible by an internal desktop application. The migration platform may include various mechanisms, including authorization, authentication, and/or verification mechanisms. The migration platform may also include an sftp server. The migration platform may be coupled to web servers via firewall. The web servers may include HTTPS/SSL and sftp servers to authenticate and manage users and to manage user sessions. The web servers may be coupled through another firewall to and external Web graphical user interface, e.g., via SOAP over HTTP requests.

Referring now to FIG. 5C, the migration platform may interact with the Trade Information Warehouse 510 via sftp/MQ and Migration Utility 530 via API. A database may be coupled to the Migration Utility 530 and the migration platform via ODBC. The migration platform may also interact via sftp with a web page that supports the download and upload of portfolio files, and participants may communicate with such a page via the internet.

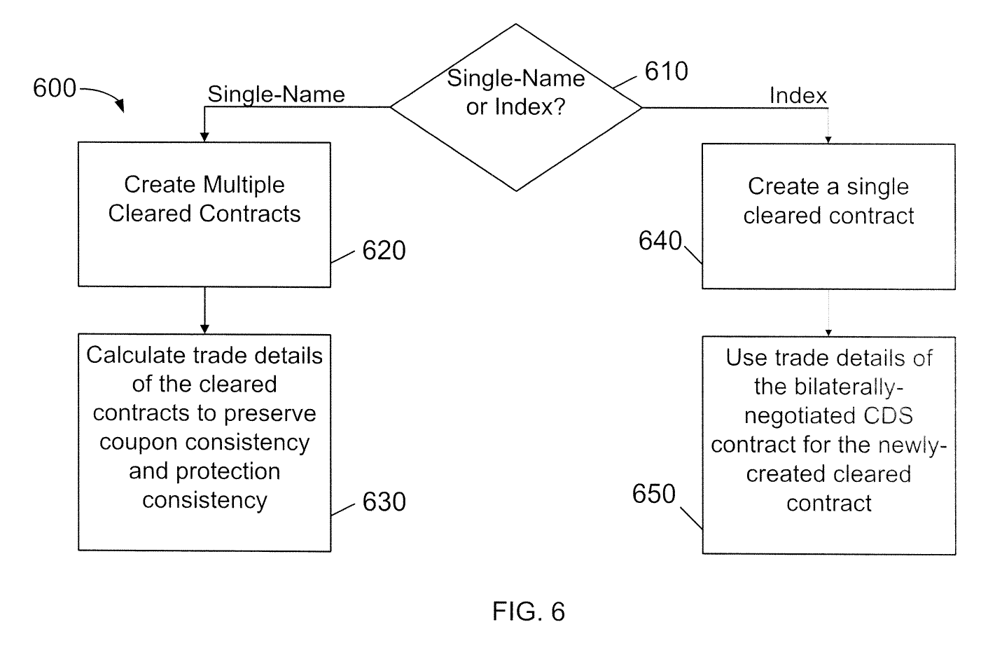

FIG. 6 illustrates one exemplary process 600 of converting, including re-couponing a single bilaterally-negotiated CDS contract to a standardized exchange-traded CDS contract (“cleared contract”). The process 600 may begin by determining whether the bilaterally-negotiated CDS contract to be converted is a single-name CDS contract or an index CDS contract (block 610).

If the bilaterally-negotiated CDS contract to be migrated is an index CDS contract, then a single cleared contract may be created (block 640). The trade details of the resulting cleared contract (e.g., the notional amount, coupon, restructuring type and maturity date) may be substantially the same as those of the bilaterally-negotiated index CDS contract (block 650), and the conversion to a cleared contract may simply require matching characteristics of the index contract to a corresponding cleared contract. For example, an index CDS contract CDX.NA.IG 6/13 USD 200M @ 155 bp with semi-annual Coupon and maturity of Sep. 20, 2016 may get converted to a cleared contract CDX.NA.IG 6/13 USD 200M @ 155 bp with semi-annual Coupon and maturity of Sep. 20, 2016.

One the other hand, if the bilaterally-negotiated CDS contract to be migrated is a single-name CDS contract, conversion may result in re-couponing and a creation of multiple cleared contracts (block 620). The trade details of the resulting cleared contracts (e.g., the notional amounts, coupons, restructuring types and maturity dates) may be calculated such that coupon consistency and protection consistency is maintained (block 630).

In one implementation, conversion of a single-name CDS contract may result in two standardized contracts, and trade details of the resulting cleared contracts (e.g., the notional amount, coupon, restructuring type and maturity date) may be calculated such that coupon consistency and protection consistency is maintained. As an example, if N₁ and C₁ are the notional amount and the coupon rate of the resulting first newly-created contract, N₁ and C₂ are the notional amount and the coupon rate of the resulting second newly-created contract, and N_{OTC} and C_{OTC} are the notional amount and the coupon rate of the original bilaterally-negotiated single-rank CDS contract, then coupon consistency and protection consistency are preserved in the conversion if the following two linear equations are satisfied:

C₁N₁+C₂N₂−C_{OTC}N_{OTC}

N₁+N₂=N_{OTC}

Following is an example to illustrate the exemplary process 600 discussed in reference to FIG. 6. Company XYZ has a CDS contract of $5 million at 300 basis points (bps), maturing in September of 2013. Converting this CDS to a standard contract may result in two cleared contracts—one at 100 bps and one at 500 bps. The notional amounts of the newly created contracts may be calculated such that the following equations are satisfied:

100N₁+500N₂=1,500M

N₁+N₂=5M

Solving the above equations we get N₁=2.5M and N₂=2.5M. Accordingly, converting this CDS to a standardized form may result in two cleared contracts, one of 2.5 million at 100 bps, maturing in September of 2013 and one of 2.5 million at 500 bps, maturing in September of 2013. It should be noted that the new standardized contracts, or trades, maintain the same market risk at the original non-standard CDS contract.

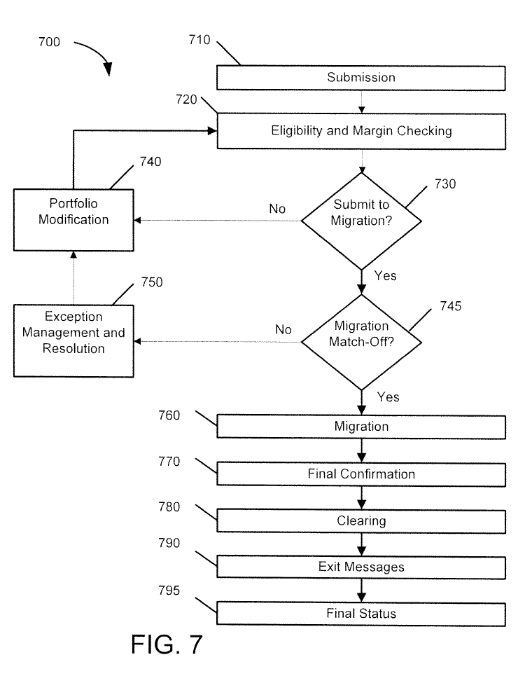

FIG. 7 illustrates one exemplary process 700 of converting a portfolio of bilateral CDS contracts to a standardized form and migrating it to the Central Counterparty Clearing Entity 520. Before participating in the migration, participants may be required to formally agree to the migration of their CDS contracts to the Central Counterparty Clearing Entity 520 (e.g., by signing agreements amongst each other and with the Central Counterparty Clearing Entity 520). In other words, the participants may be require to agree to the Central Counterparty Clearing Entity 520 being their new counterparty. For the purposes of security and accounting, the participants may also be required to obtain some sort of membership, or sponsorship, from the Central Counterparty Clearing Entity 520.

Participants of the Migration Utility 530 may then submit a list of OTC Derivative positions via the Migration Utility 530 (block 710). This list can be in various formats including FPML, FIXML, DTCC TIW Daily Recon Position Report formats. The participant can optionally add fields for Seniority and Restructuring if these fields are missing from the original submission. The additional fields may be used for optional enrichment of position files with additional attributes like seniority and restructuring information. Some sources, like DTCC may not provide unambiguous seniority and restructuring information in all scenarios. These factors may be material to eligibility and margin requirements. If not specified, seniority and restructuring may be inferred based on an inference process described below and the participant may review and validate the inferred fields. Participants may upload their positions over https, via the web interface, ftp, sftp, etc., and interact with the Migration Utility 530. In one implementation, positions may be uploaded via an automated process.

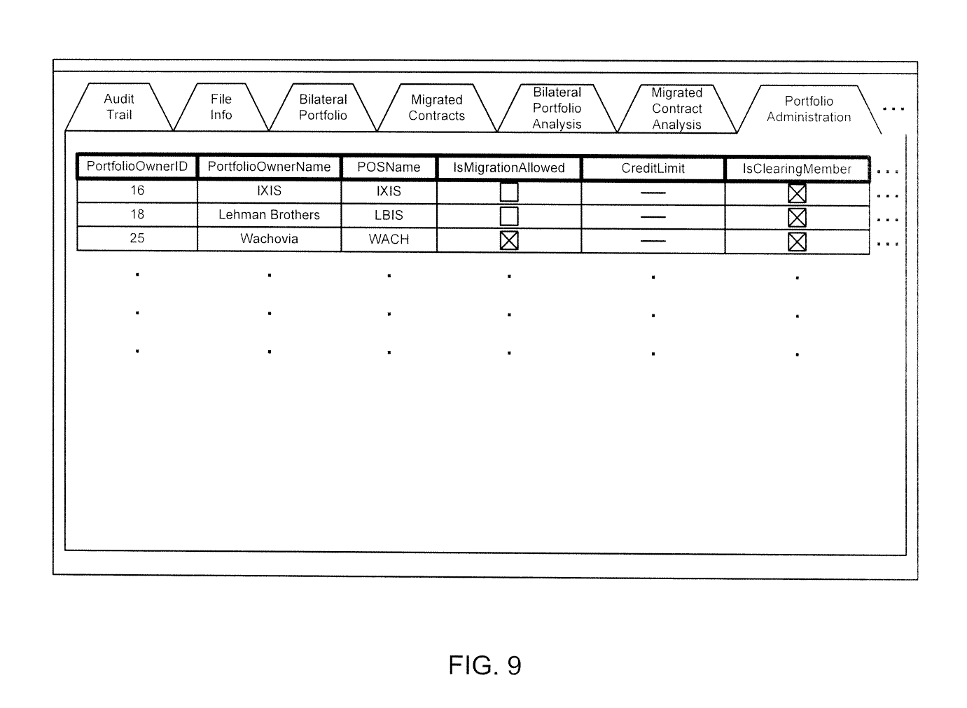

Participants may upload their positions either to a Trade Information Warehouse 510 or directly to the Migration Utility 530 (e.g., via a graphical user interface, as described blow in reference to FIGS. 9-19). If the participants submit their bilateral CDS contracts to the Trade Information Warehouse 510, participants may need to give the Migration Utility 530 access to these contracts in the Trade Information Warehouse 510 so that the Migration Utility 530 can retrieve them (e.g., at a specific time). In some implementations, participants may also have to sign an agreement, allowing the Migration Utility 530 to access their contracts in the Trade Information Warehouse 510. In some implementations, the bilateral CDS contracts may have to be stored in a particular file format that the Migration Utility 530 may recognize.

After the participants submit their CDS contracts to the Trade Information Warehouse 510 and give the Migration Utility 530 access to these contracts, the Migration Utility 530 may perform an eligibility and margin check (block 720), which would allow the participants to test eligibility of their portfolios and view associated margin requirements. The eligibility and margin check may perform a number of functions. First, eligibility and margin check may identify bilateral CDS contracts that are ineligible for migration. Examples of ineligible contracts include CDS contracts that are not in a certain predefined status with the Trade Information Warehouse 510 or contracts that are not within the scope of products permitted by the Center Counterparty Clearing Entity 520, contracts that do not correspond to any of the counterparty's contracts or corresponding CDS contracts that differ in trade details (e.g., different coupon rates), CDS contracts that are in a certain exception Status. CDS contracts that are not within the scope of available products, non-sovereign contracts, and so on.

The list of ineligible contracts may be provided to participants in a number of ways. In one implementation, participants may be given access to a downloadable status file that includes eligibility of all contacts submitted to the eligibility and margin check process, as well as any enrichment that occurred. The downloadable status file may include only those contracts eligible for migration as well as any possible enrichment. The downloadable status file may include the original OTC Derivative contracts that were submitted as well as the cleared contracts at the pre-determined standardized coupons.

In one implementation, participants may also be given access to an eligibility file. The eligibility file may include results of a simulated conversion, executed according to a conversion process, such as the process 600 discussed in reference to FIG. 6, for each eligible CDS contract. As explained in reference to FIG. 6, in some implementations, index CDS contracts may be converted on a one-to-one basis and single-name contracts may be converted, for example, on a one-to-two basis, each generating, for example, a 100 bps contract and a 500 bps contract.

The eligibility file may also include the accrued premium from the last coupon date to the migration date. Potential issues may arise with long or short premium coupons for single-name contracts with relatively recent coupon dates. The eligibility and margin check may address these issues by flagging contracts with relatively recent coupon dates. The eligibility and margin check may further inform the participants that any settlement for long or short premium coupons should be done bilaterally, independent of the migration process, and that such settlements are the participants' responsibility.

The eligibility file may also include premium leg accrual requirements assuming all eligible contracts are migrated. The eligibility file may further include the clearing account by which the contract will be cleared.

The eligibility and margin check may further check the portfolio of trade against the migration credit limit check as provided by the Central Counterparty Clearing Entity 520. This separate credit limit can be established for migration purposes to ensure that day-of trading activity does not affect the results of migration.

The eligibility and margin check may further calculate performance bond requirements on the newly substituted portfolio of trades netted with the rest of the participants' trades against the Clear House. The real-time netted portfolio can be used to generate performance bond requirements.

The eligibility and margin check may further provide margins, using various methods. In one implementation, if the file being run through the eligibility and margin check process is the first file to be margined in the current migration cycle, then the margin number displayed may be used for only this one file. If the participant has already submitted other file(s) for migration in the current migration cycle, then the margin number displayed may be the aggregate margin for the current file and all contracts already submitted for clearing in the current migration cycle.

The eligibility and margin check may also include projections assuming all eligible and matched contracts are migrated. Such projections may include netted positions, premium leg accrual requirements, determination of the clearing positions would fall within credit/limit checks, and indicative performance bond requirements that may be generated based on the netted positions of the pre-existing cleared trades as of close of the previous trading day and the to-be migrated trades (the marks used to generate bond requirements may be as of close of the previous trading day).

After reviewing the results of the eligibility and margin check, participants may decide whether to submit their original contracts to migration (block 730). If participants are not content with the results of the eligibility and margin check, or they express a desire to change their submitted portfolio, participants may enter into a cycle to modify the portfolio, i.e., the list of contracts in the portfolio, to be migrated into the Central Counterparty Clearing Entity 520 (block 740). In one implementation, consent of a counterparty would be required before any participant makes any modification to the portfolio.

After modifying the portfolios, participants may once again run the eligibility and margin check to identify ineligible contracts in the modified portfolio, check the standing on migration credit limits, performance bond requirements, and premium leg accrual, and so on (block 720). The cycle may continue until the parties are satisfied with the results of the migration simulation.

Once the parties are content with the results of the eligibility and margin check, they may submit a portion, or all, of their portfolios for the actual migration, but participants may be required to submit their final portfolios to the eligibility and margin check before ultimately submitting these portfolios to migration. Participants may be required to demonstrate that they confirmed with then counterparties that they are migrating the same deals. They may further be require to confirm that the resulting performance bond requirements will be acceptable according to other standards (e.g., fall within certain established limits). In sonic implementations, confirmation of the above may be done on a contract-by-contract basis.

Once participants submit their portfolios for migration, the Migration Utility 530 may perform a migration match-off test (block 745). The migration match-off test may collect all data that has been submitted for migration, match sides of contracts, and evaluate for exceptions in contract terms. The migration Utility 530 may allow for the evaluation of all migrated portfolios for credit limits, eligibility, position and counter party concentration. The Migration Utility 530 analysis tool may aid in the identification of portfolios and positions that exceed margin guidelines, concentration limits or credit limits. The Migration Utility 530 may include an administration interface, which may support setting a migration credit limit, counter-party information, clearing information prior to completing the migration cycle.

If the migration match-off test fails, participants may once again be given an opportunity to adjust their portfolios and the Migration Utility 530 may aid in resolving various exceptions prior to and during the migration cycle (block 750). In some implementations, the migrated portfolios can be evaluated in for credit limits and eligibility (either by the Migration Utility 530 or by the Central Counterparty Clearing Entity 520). The Central Counterparty Clearing Entity 520 may also confirm permission to clear through indicated clearing accounts (e.g., for non-clearing members). Furthermore, toxic assets may be identified, and the Central Counterparty Clearing Entity 520 may at any point up to final confirmation choose to reject positions being migrated. A number of mechanisms can be used to identify toxic assets. In some implementations, thresholds (e.g., maximum number of contracts or maximum dollar value) may be associated with individual assets (e.g., assets of a given entity). If the threshold is passed, e.g., if more than a predetermined number of CDS contracts list company Y as a reference entity, the assets of company Y may be marked as toxic and rejected from migrating into the Central Counterparty Clearing Entity 520.

In some implementations, the Central Counterparty Clearing Entity 520 may execute an exception management routine as part of migration to also monitor for, e.g., exceeded credit limits or ineligible positions in the final submission for migration. If such event occur, discussions may be opened with the infracting party to evaluate if the issue can be resolved without changing the composition of the submitted portfolio. Based on the results of the initial discussion, additional counterparties may be brought in negotiations to determine how any changes in portfolio composition (and the resulting inability to migrate their sides of the trade) will affect their migration results. As a last resort, the Central Counterparty Clearing Entity 520 may cancel the cycle and reschedule to give counterparties a chance to re-negotiate which positions to migrate.

Once the participants are content with the portfolios submitted for migration (block 730) and the match-off test passes (block 745), the Migration Utility 530 may perform the actual migration in accordance with the process similar to process 600 discussed in reference to FIG. 6 and migrate the participants' portfolios into the Central Counterparty Clearing Entity 520 (block 760). In one implementation, a final confirmation may be performed (block 770) upon completion of migration (block 760) but prior to clearing (block 780). In some implementations, participants may only be asked for final confirmation if not all of their contracts migrated as submitted. If asked for final confirmation, participants may be given the opportunity to review the final results before confirming. If at any point prior to final confirmation a participant decides not to proceed with migration, the participant's latest portfolio may be saved to be migrated at a later time (if the user so desires). The participant may download and edit, but the participant may be required tore-run the portfolio through the eligibility and margin check before the portfolio can be migrated.

In the event that the participant confirms, the Migration Utility 530 may proceed to clearing (block 780). In the event that participant choose to not to confirm, the Central Counterparty Clearing Entity 520 may work with them to adjust migration credit limits that allow for migration to proceed. The Central Counterparty Clearing Entity 520 may also work with participants to modify portfolios for migration that are acceptable across all cycle participants that allow for migration to proceed, or to cancellation and rescheduling of the migration cycle.

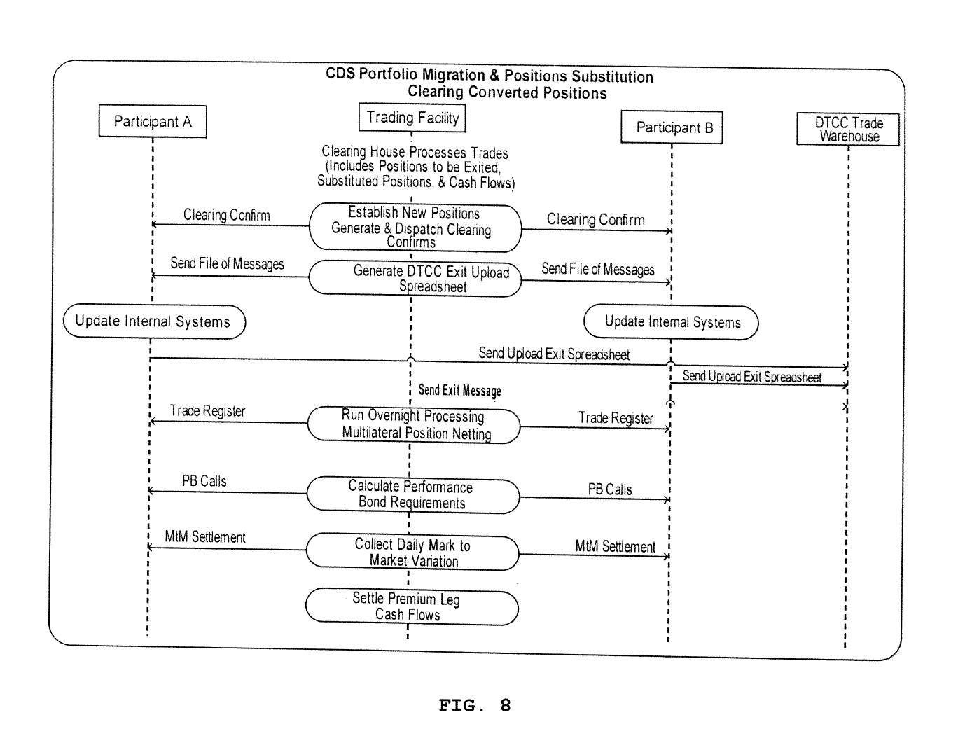

FIG. 8 illustrates an exemplary process for clearing converted contracts. A trading facility (e.g., the Central Counterparty Clearing Entity 520) may process the converted contracts, establish new positions, and generate and dispatch clearing confirmations to participants. The trading facility can then generate a Trade Information Warehouse 510 exit upload file (e.g., a spreadsheet) and send a file of messages to the participants. Participants may then update their internal systems and send upload exit files (e.g., spreadsheets) to the Trade Information Warehouse 510. The trading facility can then run overnight processing multilateral position netting and send trade registers to the participants. The trading facility can further calculate performance bond requirements and generate PB calls to the participants. The trading facility can the collect daily mark to market (MtM) variation and send MtM settlements to the participants. The trading facility can then settle premium leg cash flows.

Referring now back to FIG. 7, once the contracts have been cleared by the Central Counterparty Clearing Entity 520 (block 780), exit messages can be sent to the Trade Information Warehouse 510 (block 790) (e.g., in case that has not already been done as part of the clearing process discussed in reference to FIG. 8). These messages may indicate that the bilaterally-negotiated contracts in the Trade Information Warehouse 510 that correspond to the newly-cleared contracts are no longer valid. Accordingly, the Trade Information Warehouse 510 may invalidate and/or remove such contracts from its database.

Finally, participants may be provided with a final status report (block 795). Again, such a report may be in various forms, including but not limited to a downloadable file.

### Graphical User Interface

FIGS. 9-29 illustrate exemplary interface embodiments of the Migration Utility 530.

FIG. 9 illustrates an exemplary interface embodiment for administrating portfolios. The Migration Utility 530 may be configured to display to an administrator a list of portfolios and the corresponding portfolio owners, portfolio names, dates (e.g., date of the last modification), and so on. The Migration Utility 530 may be further configured to allow an administrator to view the details of these portfolios and to generally group, sort, and administer these portfolios as the administrator sees fit.

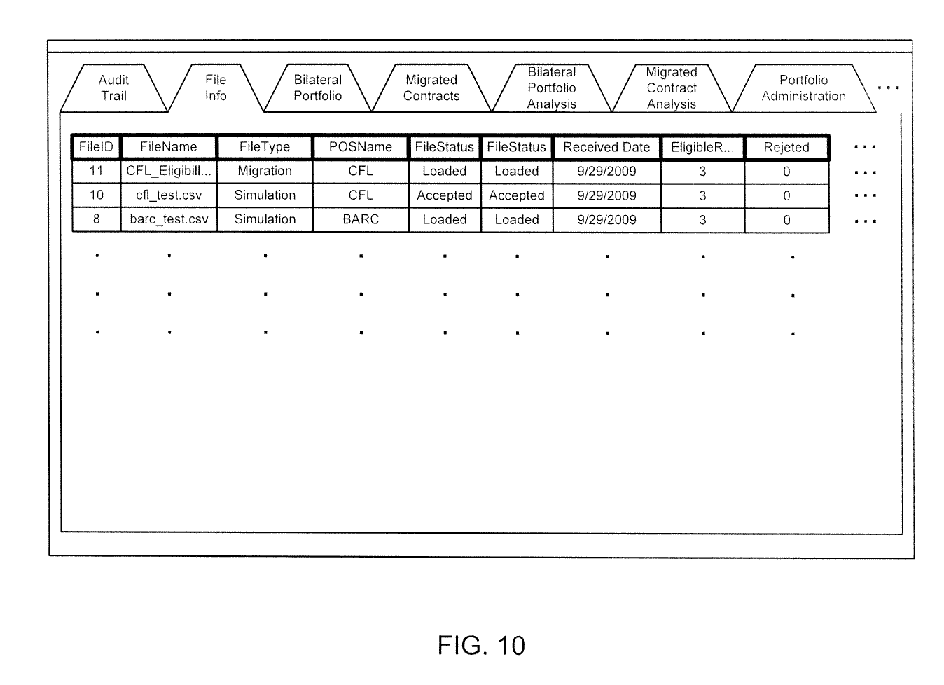

FIG. 10 illustrates an exemplary interface embodiment for viewing portfolio input status and information. The Migration Utility 530 may be configured to display a list of uploaded portfolios (e.g., via a blotter) and the corresponding portfolio owners, portfolio names, dates (e.g., date of the last modification), and so on. The Migration Utility 530 may further be configured to display the number of loaded rows, rejected rows, and file rows for each portfolio, where a row may correspond to an individual contract within a portfolio.

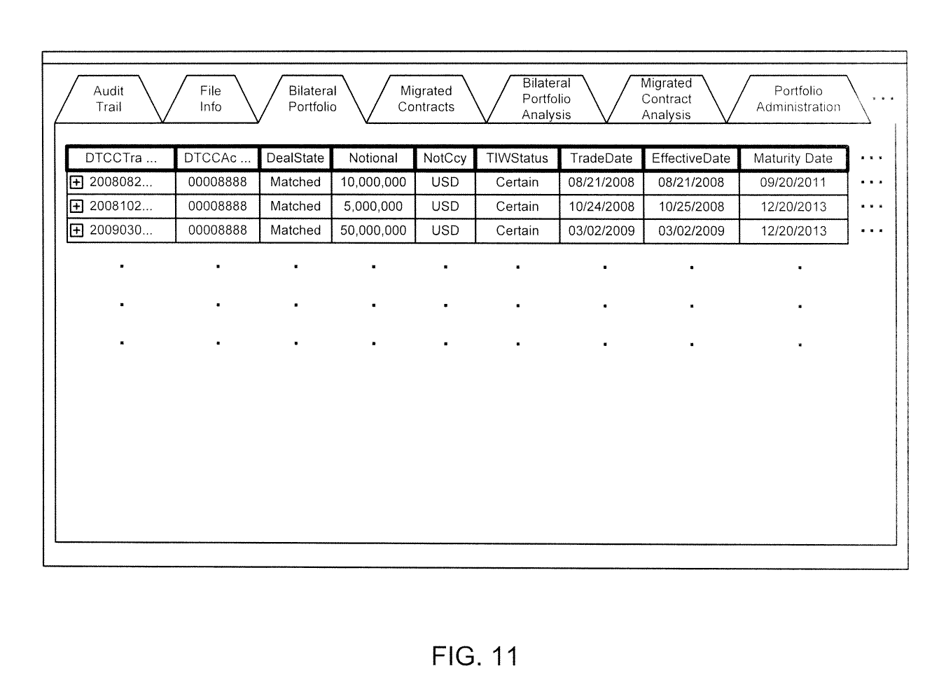

FIG. 11 illustrates an exemplary interface embodiment for viewing portfolios of bilaterally-negotiated contracts. The Migration Utility 530 may be configured to display (e.g., via a blotter) a list of bilaterally-negotiate contracts. For each such contract, the Migration Utility 530 may display an account number and names (e.g., reference name) and dates e.g., trade date, effective date and maturity date), trade information about the contract (e.g., notional amount, coupon, and so on), the currency associated with the contract, the status or the contract within the Trade Information Warehouse 510, and whether the contract is a buy-side or a sell-side contract. For each contract, the Migration Utility 530 may further display similar information about the corresponding contract of a counterparty.

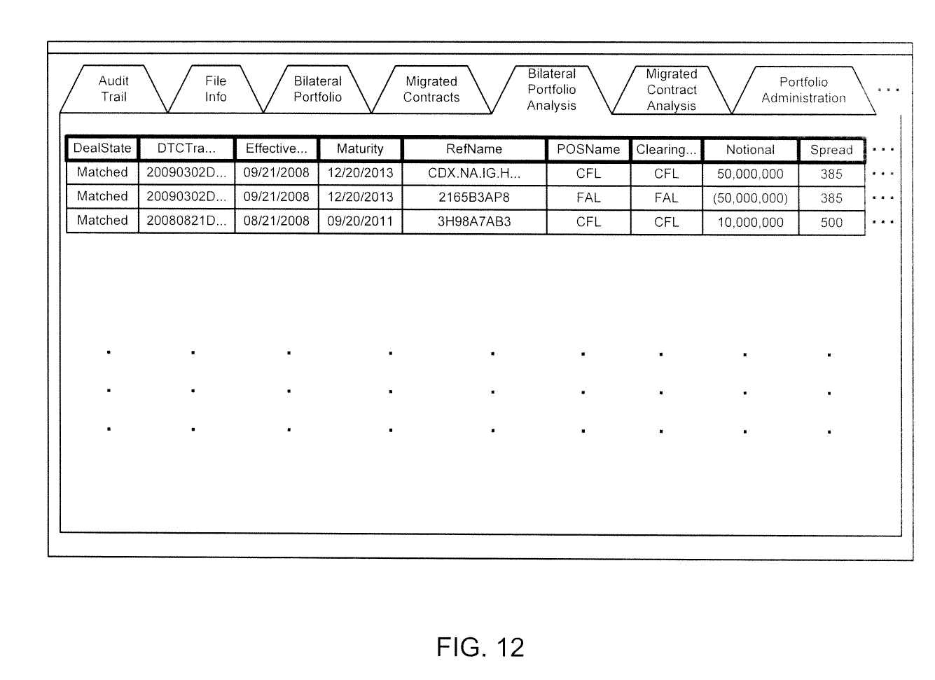

FIG. 12 illustrates an exemplary interface embodiment for viewing portfolios of migrated contracts. The Migration Utility 530 may be configured to display a list of migrated contracts. For each such contract, the Migration Utility 530 may display an account number and names (e.g., reference name) and dates (e.g., effective date and maturity date), trade information about the contract (e.g., notional amount, coupon, spread, and so on), the currency associated with the contract, the status of the contract within the Central Counterparty Clearing Entity 520 and information about the Central Counterparty Clearing Entity 520 itself.

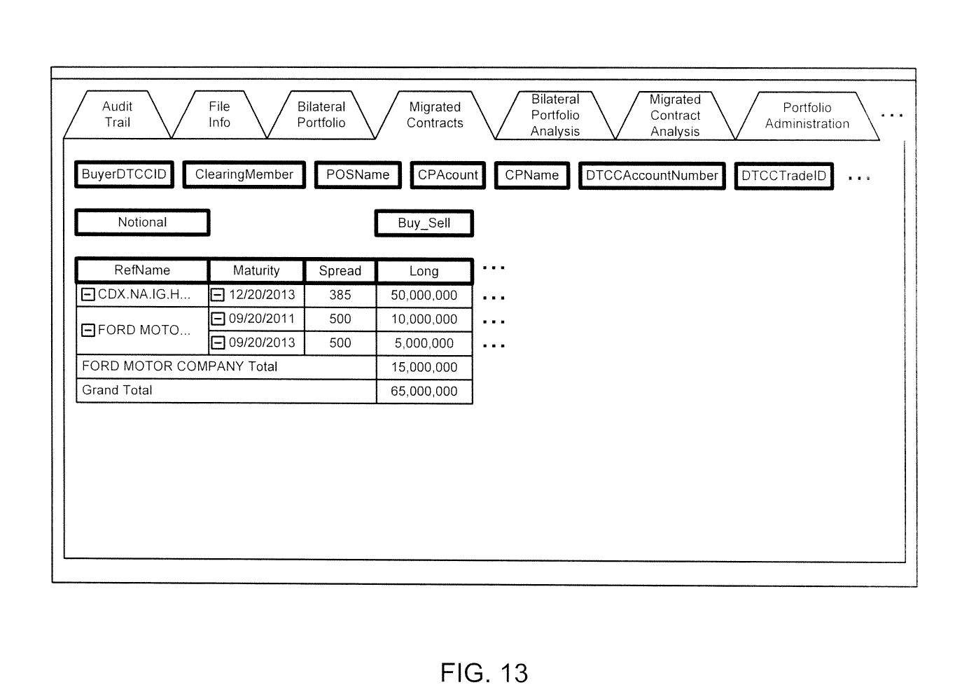

FIG. 13 illustrates an exemplary interface embodiment for analyzing portfolios of uploaded bilaterally-negotiated contracts. For each portfolio the Migration Utility 530 may include a list of contracts, along with information associated with those contracts (e.g., reference name, maturity date, spread, long value, short value, grand total, and so on).

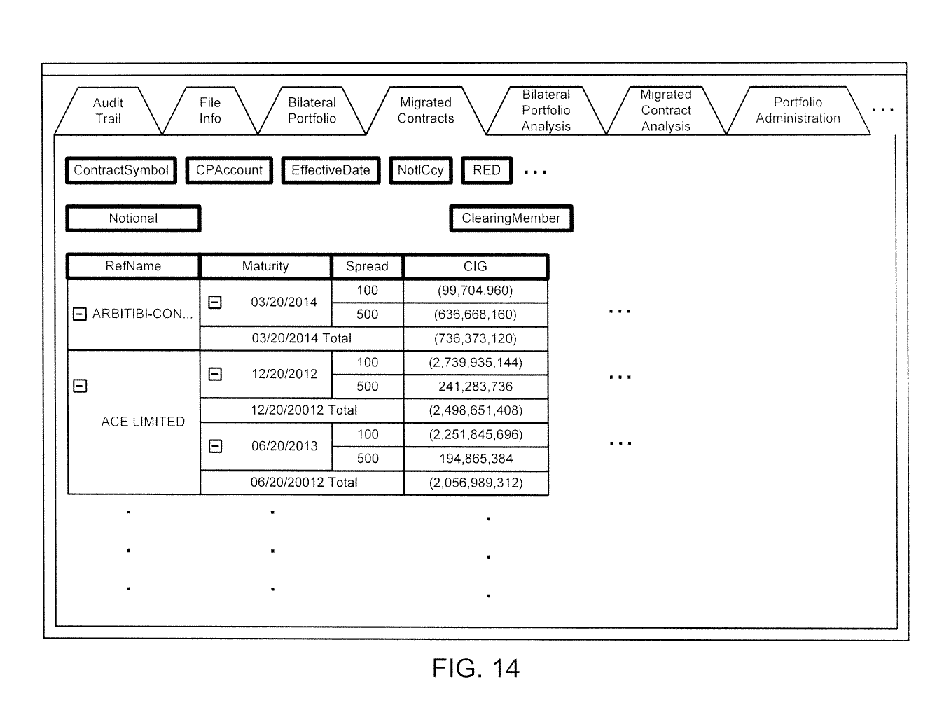

FIG. 14 illustrates an exemplary interface embodiment for analyzing portfolios of migrated and cleared contracts. For each portfolio, the Migration Utility 530 may include a list of contracts, along with information associated with those contracts (e.g., reference name, maturity date, spread, clearing member, and so on).

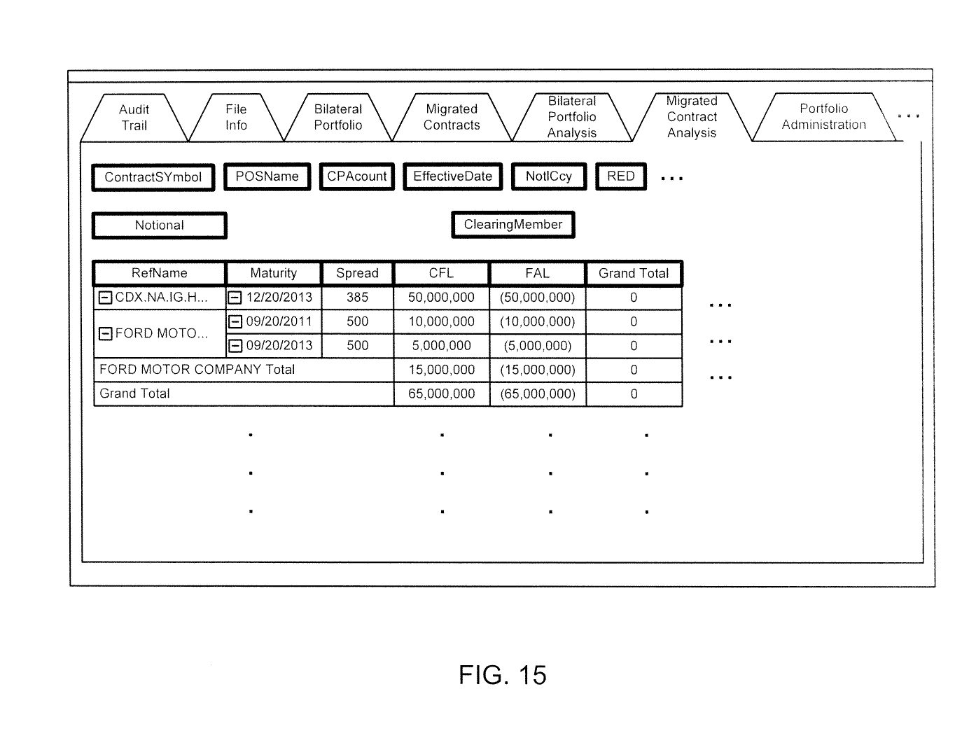

FIG. 15 illustrates an exemplary interface embodiment for analyzing the status of migrated contracts. The Migration Utility 530 may display a list of migrated contracts. For each migrated contract the Migration Utility 530 may specify primary parties and the clearing party, total number of contracts, number of paired and unpaired contracts, number of new contracts, number of matched, approved, incomplete and pending contracts, and so on.

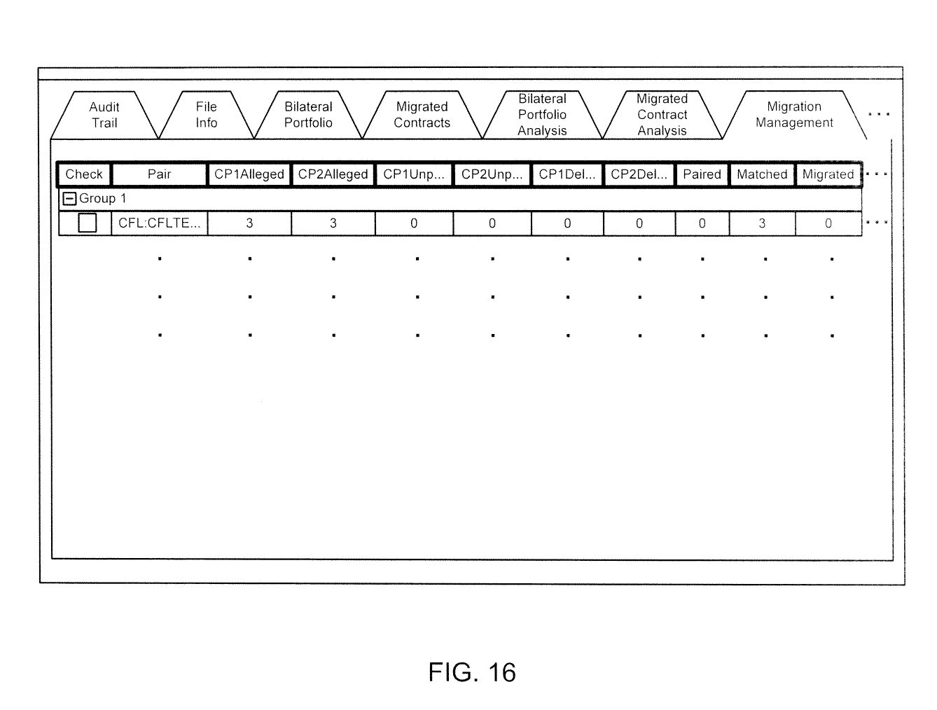

FIG. 16 illustrates an exemplary interface embodiment for viewing a migration snapshot of a portfolio of CDS contracts. For example, the Migration Utility 530 may display the number of contracts in a portfolio, the number of alleged contracts (e.g., by each party), the number of possessed and unprocessed contracts, the number of deleted contracts, the number of paired contracts, the number of matched contracts, the number of approved contracts, pending, contracts, rejected contracts, and so on.

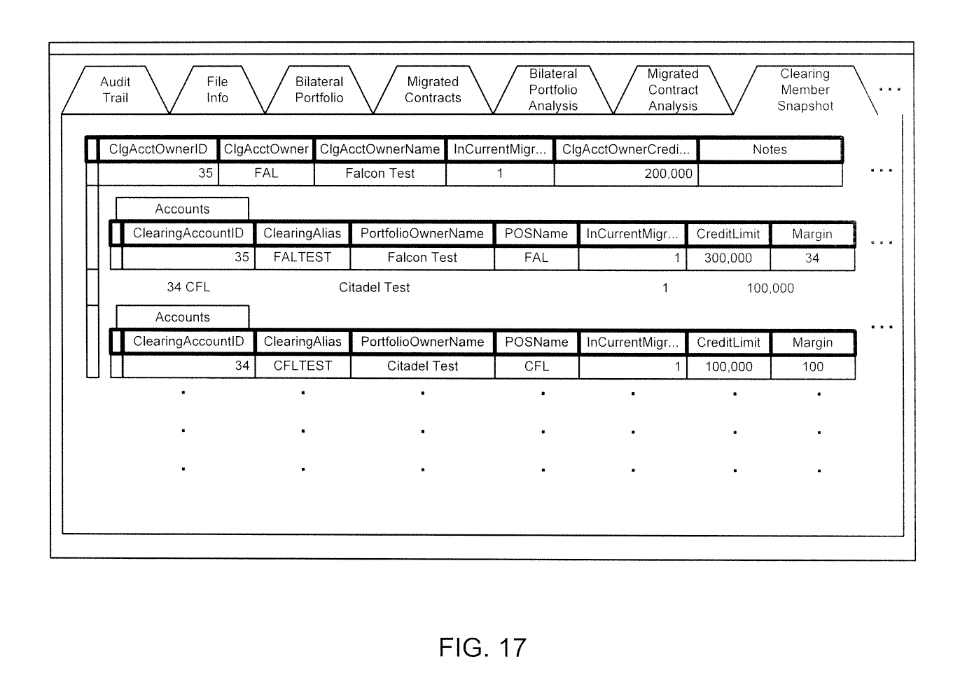

FIG. 17 illustrates an exemplary embodiment for viewing a snapshot of a given clearing member. For example, for a given clearing member, the Migration Utility 530 may display the member's identification, the alias, the portfolio owner name, the associated credit limit, margin, initial cash flow, and so on.

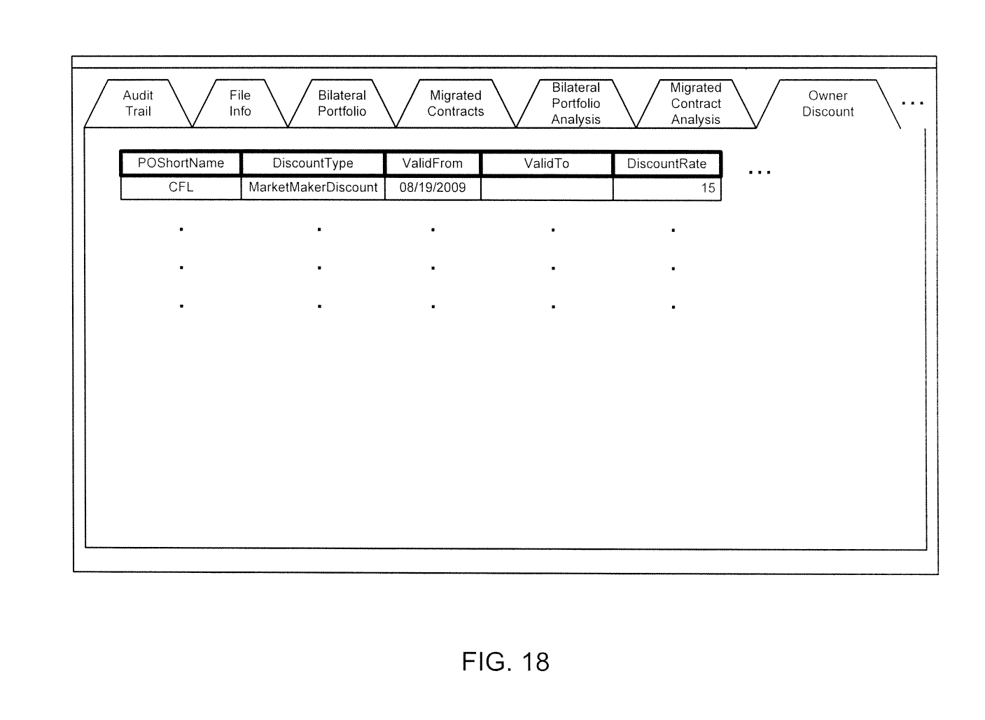

FIG. 18 illustrates an exemplary interface embodiment for viewing a discount associated with an owner. For example, the Migration Utility 530 may display a discount type, the dates during which the discount is valid, the discount rate, and so on.

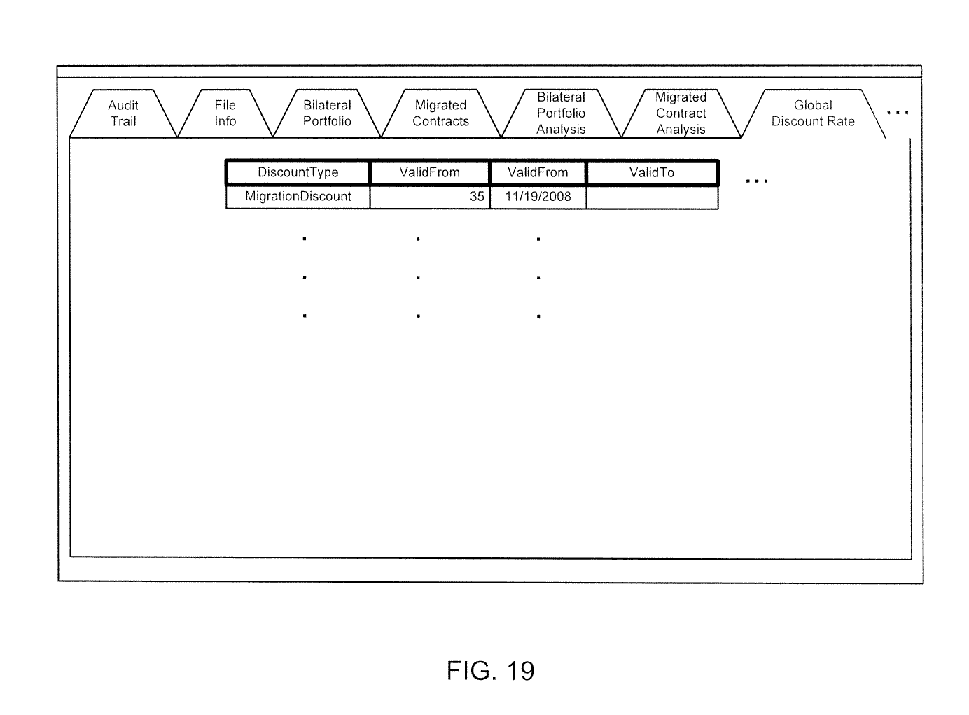

FIG. 19 illustrates an exemplary interface embodiment for viewing a global discount. For example, the Migration Utility 530 may display a discount type, the dates during which the discount is valid, the discount rate, and so on.

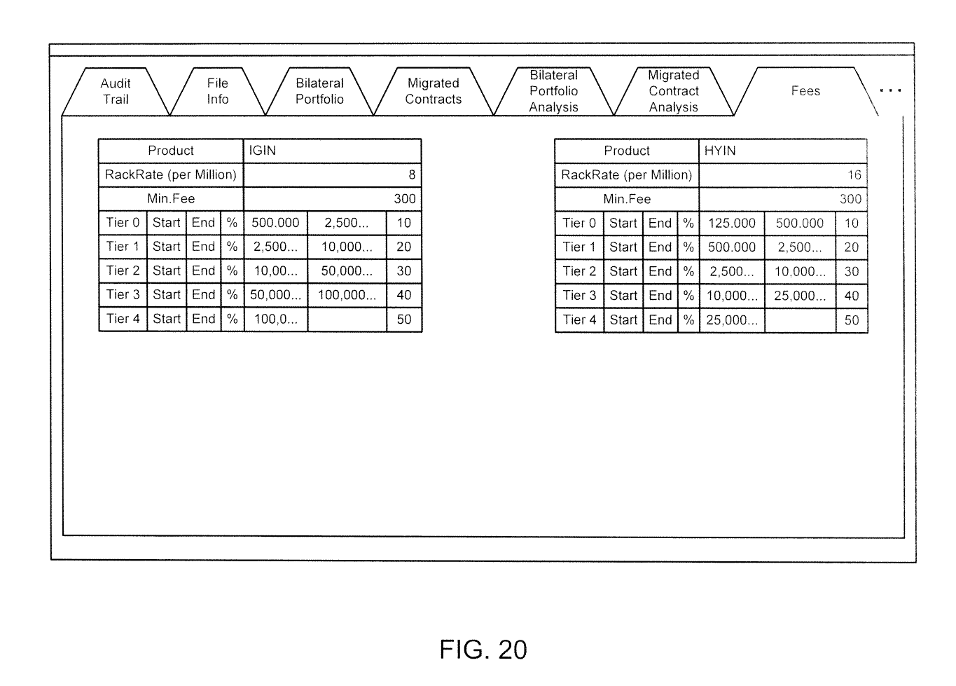

FIG. 20 illustrates an exemplary interface embodiment for viewing various fees associated with migration. For example, the Migration Utility 530 may display displays fees associated with different products. The Migration Utility 530 may further break the fees into tiers (e.g., tier 0, tier 1, tier 2, tier 3 and tier 4) and display the distribution of fees across the tiers.

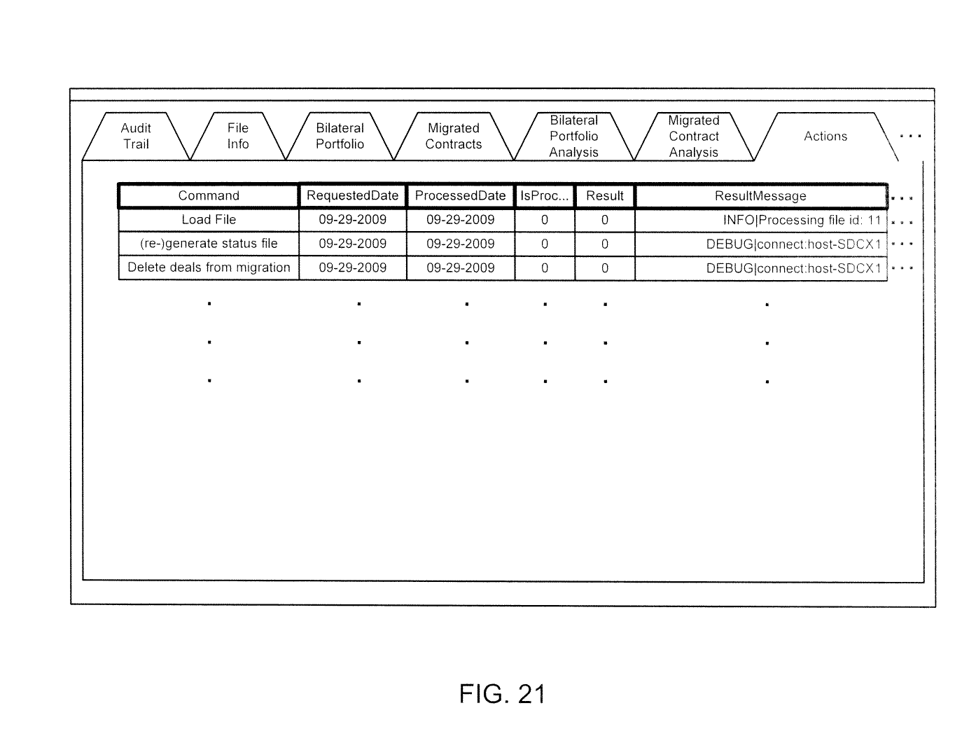

FIG. 21 illustrates an exemplary interface embodiment for viewing administrative actions associated with migration. For example, the Migration Utility 530 may display when different files were loaded and processed. The Migration Utility 530 may further display the result of the processing of uploaded files. The Migration Utility 530 may also display when status files were generated (or regenerated), when deals were deleted from migration, when migration was computed (or recomputed), and so on.

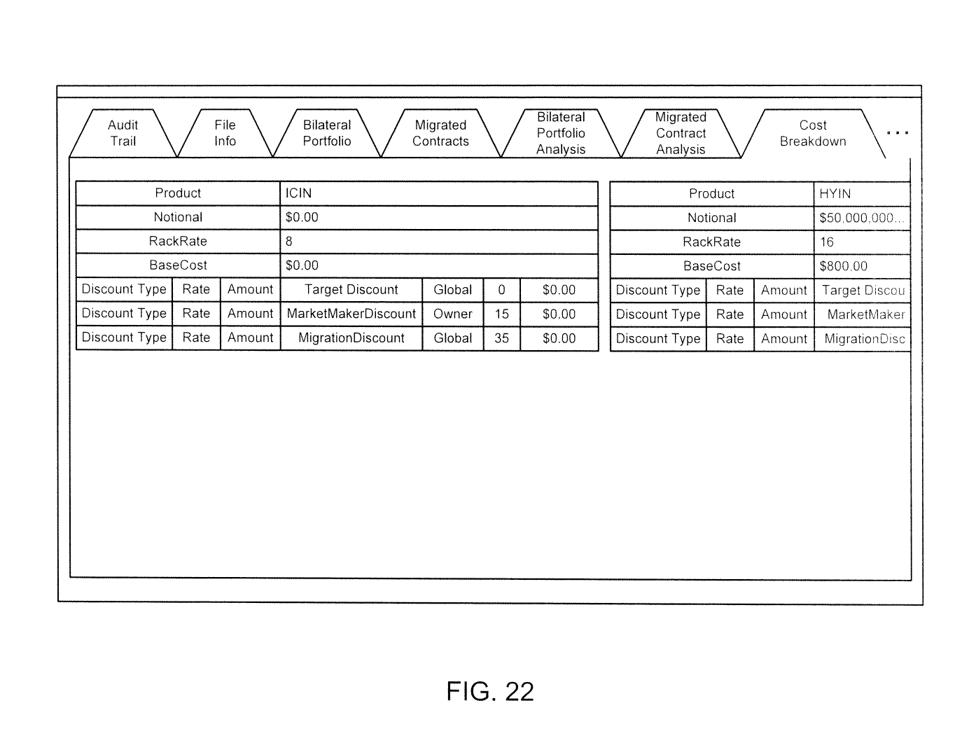

FIG. 22 illustrates an exemplary interface embodiment for viewing costs associated with migration. For example, the Migration Utility 530 may display costs associated with different products. For a given product, the Migration Utility 530 may display a notional value, a rack rate, a base costs, information related to various discounts associated with the product, and so on.

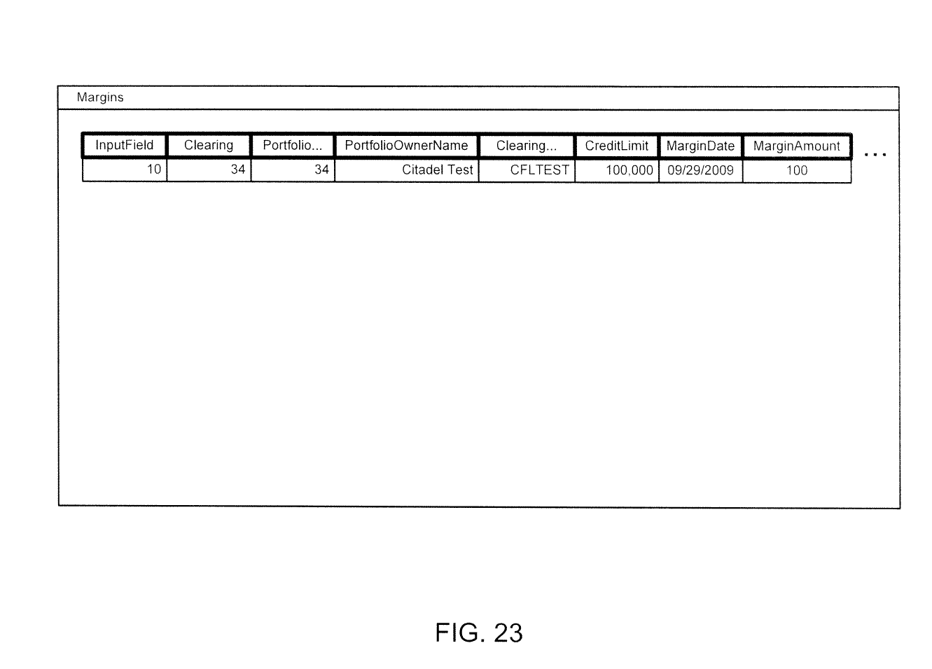

FIG. 23 illustrates an exemplary interface embodiment for viewing margin information associated with a portfolio of contracts. For example, the Migration Utility 530 may display the portfolio name and owner, the number of contracts in the portfolio, the credit limit, margin date, margin amount, initial cash flow, and so on.

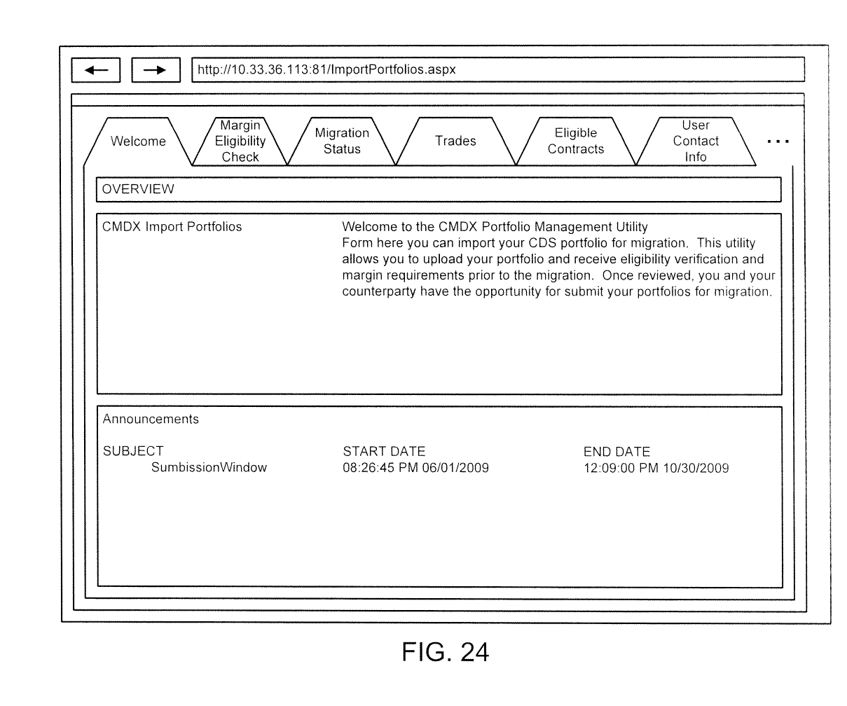

FIG. 24 illustrates an exemplary interface embodiment for displaying a migration schedule. The Migration Utility 530 may be configured to display the start mid end dates of portfolio submissions. The Migration Utility 530 may be further configured to display the start and end dates of migration.

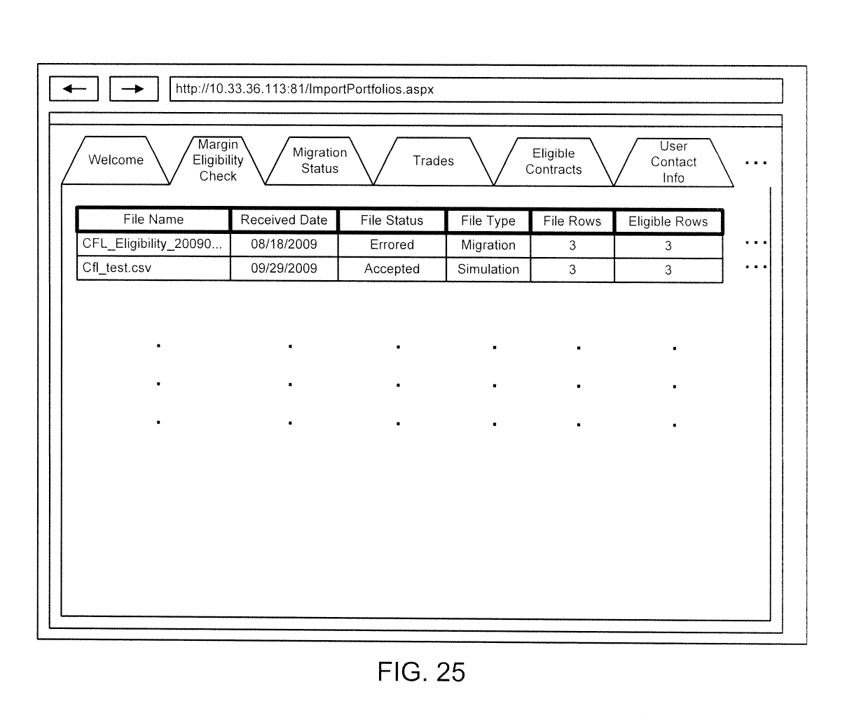

FIG. 25 illustrates an exemplary web interface embodiment for a uploading and downloading files to and from the Migration Utility 530. The Migration Utility 530 may be configured to display uploaded portfolios and information associated with those portfolios (e.g., original file name, file status, number of rows in the file, number of loaded and rejected rows, and so on). The Migration Utility 530 may further be configured to display downloadable information associated with downloadable status files. Such information may include file status, number of rows in the file, number of loaded and rejected rows, credit limit, margin, and so on. Still further, the Migration Utility 530 may be configured to display information related to the margin eligibility with respect to contracts in the uploaded portfolios.

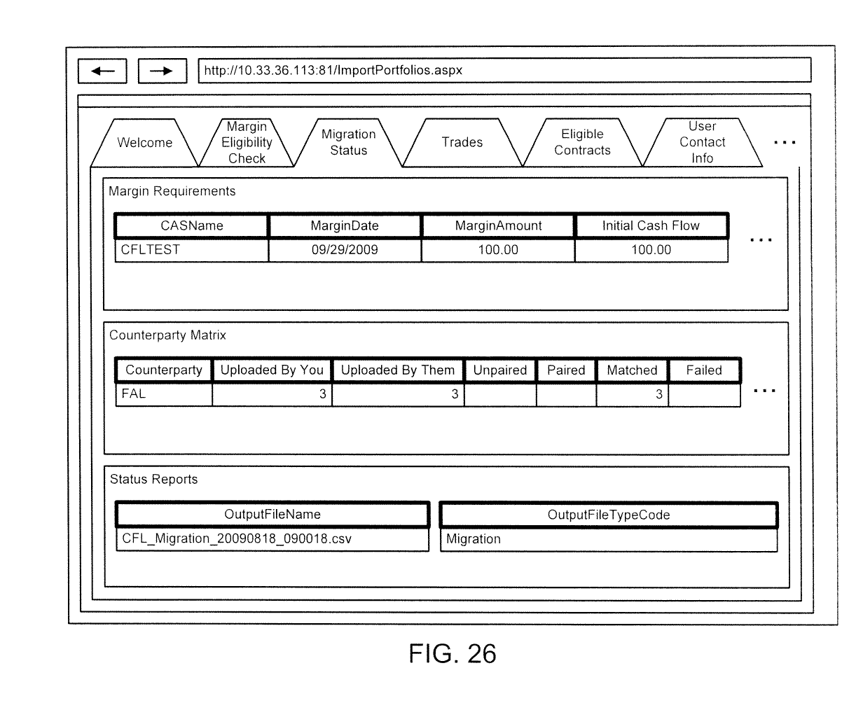

FIG. 26 illustrates an exemplary web interface embodiment for viewing the migration status. The Migration Utility 530 may be configured to display a list of counterparties and the number of contracts uploaded by different participants/counterparties. The Migration Utility 530 may further be configured to display a number of paired, unpaired, matched, pending, failed, incomplete, and migrated contracts.

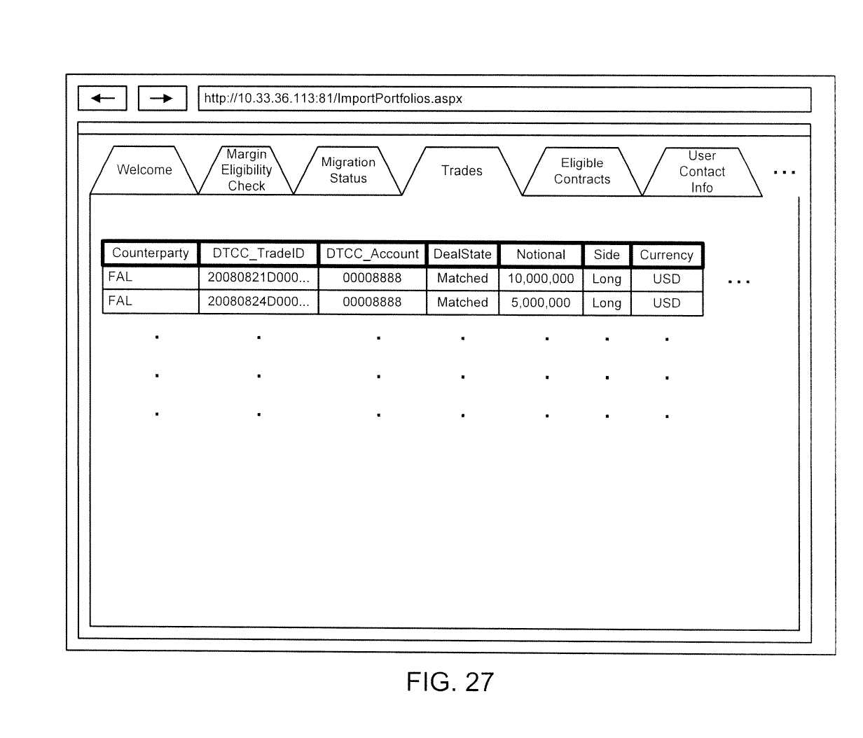

FIG. 27 illustrates an exemplary web interface embodiment for viewing the trades. For each trade, the Migration Utility 530 may be configured to display a counterparty, a trade identification, a deal state (e.g., matched or not matched), the notional value, the side (e.g., short of long), the currency (e.g., USD), the TIW status, the trade date, the effective date, the maturity date, the reference entity, and so on.

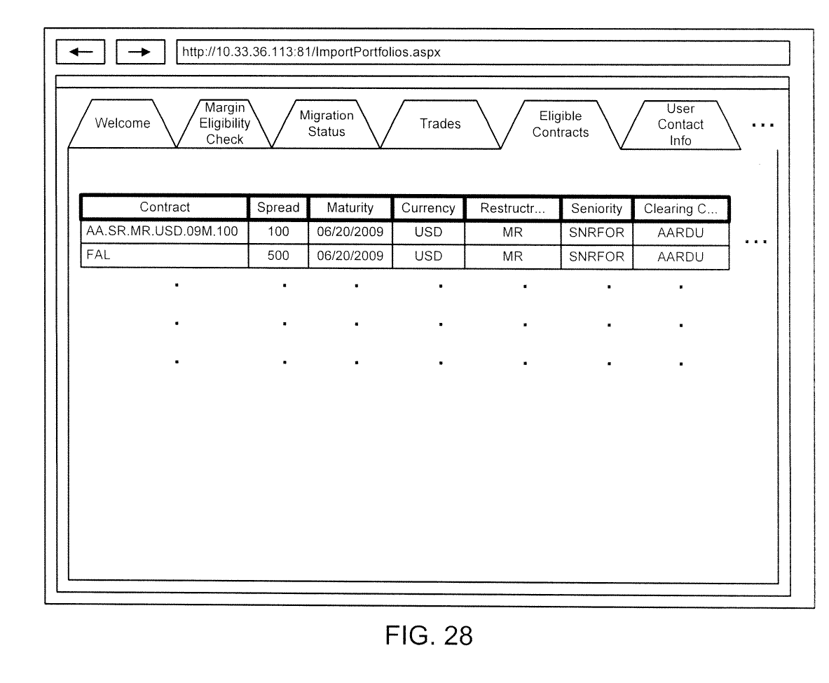

FIG. 28 illustrates an exemplary web interface embodiment for viewing eligible contracts. For example, for each contract, the Migration Utility 530 may be configured to display the spread, the maturity date, the currency, seniority, restructuring type, and so on.

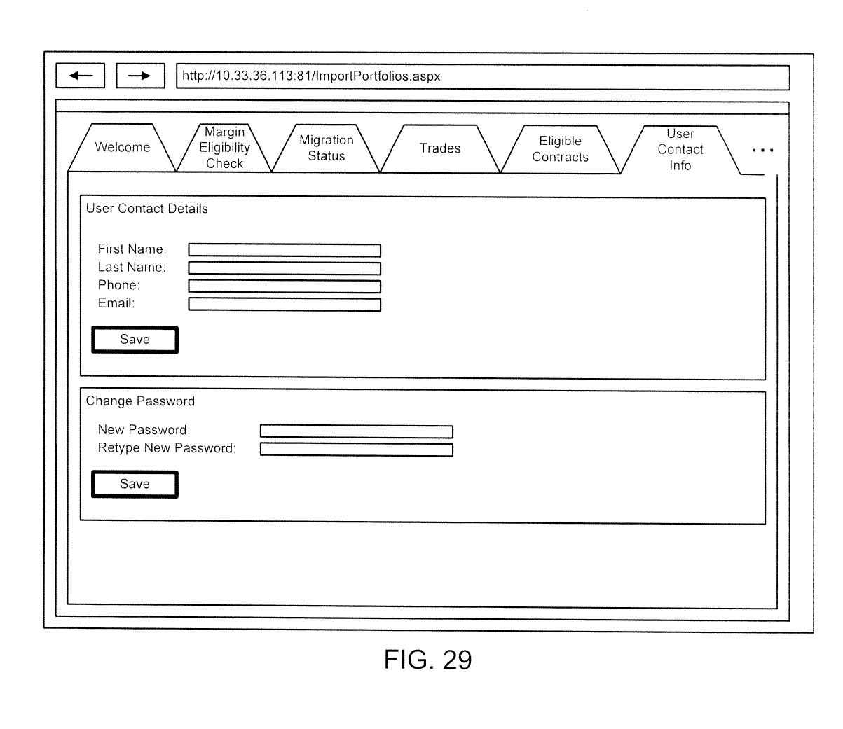

FIG. 29 illustrates an exemplary web interface embodiment for viewing various information about a user. For example, for a given user, the Migration Utility 530 may be configured to display the user's name, contact information. The Migration Utility 530 may be configured to enable the user to change the contact information, to change his or her password and other settings.

The invention has been described in terms of particular embodiments, but other embodiments can be implemented and are within the scope of the following claims.

1. A method or converting a portfolio of non-standard credit default swap (CDS) trades into standardized CDS trades for use in a migration computing system, the migration computing system having a processor and memory, the memory including computer-readable instructions, which, when executed on the processor implement a migration utility, the method comprising:
using the migration utility to receive electronically a plurality of non-standard CDS trades, wherein each of the plurality of the non-standard CDS trades includes at least an initial notional amount and an initial coupon rate;
using the migration application to convert each of the plurality of non-standard CDS trades into two standardized CDS trades, the two standardized CDS trades including a first standardized CDS trade at a first coupon rate of 100 basis points (bps) and a second standardized CDS trade at a second coupon rate of 500 bps; and
using the migration application to determine a first notional amount for the first standardized CDS trade and a second notional amount for the second standardized CDS trade such that a sum of the first notional amount and the second notional amount is equal to the initial notional amount, and a sum of the first notional amount multiplied by the first coupon rate and the second notional amount multiplied by the second coupon rate is equal to the initial notional amount multiplied by the initial coupon rate.

2. The method of claim 1, wherein using the migration utility to receive electronically the plurality of non-standard CDS trades comprises using the migration utility to receive electronically the plurality of non-standard CDS contracts via a Trade Information Warehouse (TIW), the TIW including a database of records associated with the plurality of non-standard CDS trades.

3. The method of claim 1, wherein using the mi ration utility to receive electronically the plurality of non-standard CDS trades comprises using the migration utility to receive electronically the plurality of non-standard CDS trades from a user via a graphical user interface.

4. The method of claim 1, wherein the plurality of non-standard CDS trades comprises a subset of non-standard CDS trades in a user's portfolio non-standard CDS trades, wherein the subset of non-standard CDS trades is selected by the user.

5. The method of claim 1, further comprising using the migration utility to allow a user to review and confirm the two standardized CDS trades.

6. A method of converting a non-standard credit default swap (CDS) contract into a standardized CDS contract for use in a migration computing system, the migration computing system having a processor and memory, the memory including computer-readable instructions, which, when executed on the processor implement a migration utility, the method comprising:
using the migration utility to receive electronically a non-standard credit default swap (CDS) contract having at least an initial notional amount and an initial coupon rate; and
using the migration utility to convert the non-standard CDS contract into one or more standardized CDS contracts, including using the migration utility to assign a coupon rate to each of the one or more standardized CDS contracts and to determining a notional amount for each of the one or more standardized CDS contracts such that coupon consistency and protection consistency are maintained between the non-standard CDS contract and the one or more standardized CDS contracts.

7. The method of claim 6, wherein the one or more standardized CDS contracts comprise two standardized CDS contracts including a first standardized CDS contract having a first notional amount and a first coupon rate and a second standardized CDS contract having a second notional amount and a second coupon rate.

8. The method of claim 7, wherein using the migration utility to determine a notional amount for each of the one or more standardized CDS contracts comprises using the migration utility to determine the first notional amount and the second notional amount such that a sum of the first notional amount and the second notional amount is equal to the initial notional amount, and a sum of the first notional amount multiplied by the first coupon rate and the second notional amount multiplied by the second coupon rate is equal to the initial notional amount multiplied by the initial coupon rate.

9. The method of claim 8, where using the migration utility to assign a coupon rate to each of the one or more standardized CDS contracts comprises using the migration utility to assign a first coupon rate of 100 basis points (bps) to the first standardized CDS contract and a second coupon rate of 500 basis points (bps) to the second standardized CDS contract.

10. The method of claim 6, further comprising using the migration utility to perform an eligibility and margin check on the received non-standard CDS contract to determine whether the received non-standard CDS contract is eligible to be converted.

11. The method of claim 10, wherein using the migration utility to perform an eligibility and margin check on the received non-standard CDS contract comprises using the migration utility to determine whether the received non-standard CDS contract meets predetermined margin guidelines.

12. The method of claim 6, further comprising using the migration utility to perform a simulated conversion of the non-standard CDS contract into a standardized CDS contract before using the migration utility to convert the non-standard CDS contract.

13. The method of claim 12, further comprising providing results of the simulated conversion to a user before converting the non-standard CDS contract.

14. The method of claim 13, further comprising using the migration utility to allow the user to modify the non-standard CDS contract before using the migration utility to convert the non-standard CDS contract.

15. The method of claim 6, further comprising using the migration utility to identify errors in the received non-standard CDS contract.

16. The method of claim 6, further comprising using the migration utility to identify whether the received non-standard CDS contract includes toxic assets.

17. The method of claim 6, further comprising using the migration utility to allow a user to review and accept the one or more standardized CDS contracts.

18. The method of claim 6, further comprising using the migration utility to migrate the standardized one or more standardized CDS contracts into a clearing entity and to clear the one or more standardized CDS contracts at the clearing entity.

19. A computer program product, comprising a computer usable medium having a computer readable program code embodied therein, said computer readable program code adapted to be executed to implement a method of converting a plurality of non-standard credit default swap (CDS) contracts into standardized CDS contracts, the method comprising:
receiving electronically a portfolio of non-standard CDS contracts comprising a plurality of non-standard credit default swap (CDS) contracts, wherein each of the plurality of the non-standard CDS contracts includes at least an initial notional amount and an initial coupon rate; and
converting each of the plurality of non-standard CDS contracts into one or more standardized CDS contracts, including assigning a coupon rate to each of the one or more standardized CDS contracts and determining a notional amount for each of the one or more standardized CDS contracts such that coupon consistency and protection consistency are maintained between the respective non-standard CDS contract and the one or more standardized CDS contracts.

20. The method of claim 19, wherein the one or more standardized CDS contracts corresponding to a given non-standard CDS contract in the portfolio of non-standard CDS contracts comprise two standardized CDS contracts including a first standardized CDS contract having a first notional amount and a first coupon rate and a second standardized CDS contract having a second notional amount and a second coupon rate.

21. The method of claim 20, wherein determining a notional amount for each of the one or more standardized CDS comprises determining the first notional amount and the second notional amount such that a sum of the first notional amount and the second notional amount is equal to the respective initial notional amount, and a sum of the first notional amount multiplied by the first coupon rate and the second notional amount multiplied by the second coupon rate is equal to the respective initial notional amount multiplied by the respective initial coupon rate.

22. The method of claim 21, wherein assigning a coupon rate to each of the one or more standardized CDS contracts comprises assigning a first coupon rate of 100 basis points (bps) to the first standardized CDS contract and a second coupon rate of 500 basis points (bps) to the second standardized CDS contract.

23. The method of claim 19, wherein receiving electronically a portfolio of non-standard CDS contracts comprises receiving electronically the portfolio of non-standard CDS contracts via a Trade Information Warehouse (TIW), the TIW including a database of records associated with the plurality of non-standard CDS contracts in the portfolio.

24. A system for converting a non-standard credit default swap contract (CDS) into one or more standardized CDS contracts, the system comprising a migration computing system having a processor and memory, the memory including computer-readable instructions, which, when executed on the processor implement a migration utility, the migration computing system configured to:
use the migration utility to receive electronically a plurality of non-standard credit default swap (CDS) contracts, each of the plurality of non-standard CDS contracts having at least an initial notional amount and an initial coupon rate; and
use the migration utility to convert each of the plurality of non-standard CDS contracts into one or more standardized CDS contracts, including using the migration utility to assign a coupon rate to each of the one or more standardized CDS contracts and to determine a notional amount for each of the one or more standardized CDS contracts such that coupon consistency and protection consistency are maintained between the respective non-standard CDS contract and the one or more standardized CDS contracts.

25. The system of claim 24, wherein the one or more standardized CDS contracts comprise two standardized CDS contracts including a first standardized CDS contract having a first notional amount and a first coupon rate and a second standardized CDS contract having a second notional amount and a second coupon rate.

26. The system of claim 25, wherein the migration computing system is configured to determine the first notional amount and the second notional amount such that a sum of the first notional amount and the second notional amount is equal to the initial notional amount, and a sum of the first notional amount multiplied by the first coupon rate and the second notional amount multiplied by the second coupon rate is equal to the initial notional amount multiplied by the initial coupon rate.

27. The system of claim 26, wherein the migration computing system is configured to assign a first coupon rate of 100 basis points (bps) to the first standardized CDS contract and a second coupon rate of 500 basis points (bps) to the second standardized CDS contract.

28. The system of claim 24, wherein the migration computing system is configured to use the migration utility to retrieve the plurality of non-standard CDS contracts in response to a user input via a graphical user interface.

29. The system of claim 24, wherein the migration computing system is configured to use the migration utility to display, via a blotter, the plurality of non-standard CDS contracts and information associated with the plurality of non-standard CDS contracts to a user.

30. The system of claim 28, wherein the user interface is configured to display, via a blotter, the converted standardized CDS contracts and information associated with the converted standardized CDS contracts.

31. The system of claim 30, wherein the information associated with a given converted standardized CDS contract includes one or more from a group comprising primary parties associated with the standardized CDS contract, a clearing party associated with the standardized CDS contract, and a status of the standardized CDS contract.

32. The method of claim 31, wherein the status of the given standardized CDS contract includes one or more from a group comprising paired contract, unpaired contract, new contract, matched contract, ineligible contract, unmatched contract, approved contract, incomplete contract, and pending contract.

33. A computer-readable medium recording therein a migration program that, when executed on a processor, causes a computer to execute a process comprising:
receiving electronically a non-standard credit default swap (CDS) having at least an initial notional amount and an initial coupon rate; and
converting the non-standard CDS contract into one or more standardized CDS contracts, including assigning a coupon rate to each of the one or more standardized CDS contracts and determining a notional amount for each of the one or more standardized CDS contracts such that coupon consistency and protection consistency are maintained between the non-standard CDS contract mid the one or more standardized CDS contracts.

34. The computer-readable medium of claim 33, wherein the one or more standardized CDS contracts comprise two standardized CDS contracts including a first standardized CDS contract having a first notional amount and a first coupon rate and a second standardized CDS contract having a second notional amount and a second coupon rate.

35. The computer-readable medium of claim 34, wherein a notional amount for each of the one or more standardized CDS contracts comprises determining the first notional amount and the second notional amount such that a sum of the first notional amount and the second notional amount is equal to the initial notional amount, and a sum of the first notional amount multiplied by the first coupon rate and the second notional amount multiplied by the second coupon rate is equal to the initial notional amount multiplied by the initial coupon rate.

36. The apparatus of claim 34, wherein assigning a coupon rate to each of the one or more standardized CDS contracts comprises assigning a first coupon rate of 100 basis points (bps) to the first standardized CDS contract and a second coupon rate of 500 basis points (bps) to the second standardized CDS contract.

37. A method of converting a negotiated derivative positions into standardized derivative positions for use in a migration computing system, the migration computing system having a processor and memory, the memory including computer-readable instructions, which, when executed on the processor implement a migration utility, the method comprising:
receiving electronically a negotiated derivative position having at least an initial notional amount and an initial coupon rate; and
converting the negotiated derivative position into one or more standardized derivative positions, including assigning a coupon rate to each of the one or more standardized derivative positions and determining a notional amount for each of the one or more standardized derivative positions such that coupon consistency and protection consistency are maintained between the negotiated derivative position and the one or more standardized derivative positions.

38. An apparatus having a processor and memory including computer-readable instructions executable by the processor, the apparatus comprising:
means for electronically receiving a non-standard credit default swap (CDS) contract having at least an initial notional amount and an initial coupon rate: and
means for converting the non-standard CDS contract into one or more standardized CDS contracts, including assigning a coupon rate to each of the one or more standardized CDS contracts and determining a notional amount for each or the one or more standardized CDS contracts such that coupon consistency and protection consistency are maintained between the non-standard CDS contract and the one or more standardized CDS contracts.
